(19) United States
(12) Patent Application Publication
(10) Pub. No.: US 2026/0336749 A1
(43) Pub. Date: Oct. 29, 2026

(54) BICYCLE TRANSMISSION SYSTEM

(71) Applicant: Classified Cycling BV, Antwerpen (BE)

(72) Inventor: Roëll Marie VAN DRUTEN, Eindhoven (NL)

(21) Appl. No.: 19/118,206

(22) PCT Filed: Oct. 6, 2023
(86) PCT No.: PCT/EP2023/077754

§ 371 Date: Apr. 3, 2025

(30) Foreign Application Priority Data
Oct. 7, 2022 (NL) 2033260

(51) Int. Cl. B62M 11/18

(52) U.S. Cl. CPC B62M 11/18

(57) ABSTRACT

The disclosure relates to a bicycle transmission system, comprising a three-speed planetary transmission having a planetary gear set with three rotational members that include a sun gear, a planet carrier carrying one or more planet gears, and a ring gear. The three-speed planetary transmission comprises a first actuatable clutch module and a second actuatable clutch module for selectively switching between any of the three different transmission ratios.

### FIELD

The invention relates to a bicycle transmission system

### BACKGROUND

Conventional bicycle transmission systems may include a derailleur for shifting a chain between differently sized sprockets, so as to selectively provide different transmission ratios from an input crank to a driven wheel. An alternative to derailleurs is formed by hub transmissions, where shifting of gears is accommodated by a gear shifting mechanism inside the wheel hub of the driven wheel. One or more planetary gear sets typically provide multiple selectable transmission ratios for a hub transmission. Hub transmissions with a three-speed planetary gear set are for example well know.

### SUMMARY

It is an aim to propose an improved bicycle transmission, particularly a hub transmission or a crank transmission. In a more general sense it is an object to overcome or ameliorate at least one of the disadvantages of the prior art, or at least provide alternative processes and structures that are more effective than the prior art. At any rate it is at the very least aimed to offer a useful choice and contribution to the existing art.

According to an aspect, a bicycle transmission system is provided. The bicycle transmission comprises a planetary transmission having three rotational members. The planetary transmission comprises a first clutch module and/or a second clutch module. The first clutch module includes a first actuatable clutch in a transmission path between a planetary transmission input and a first one of the rotational members, and a first freewheel in a transmission path between the planetary transmission input and a second one of the rotational members. The second clutch module includes a second actuatable clutch in a transmission path between the second one of the rotational members and a planetary transmission output, and a second freewheel in a transmission path between the first one of the rotational members and the planetary transmission output. A third one of the rotational members is non-rotatably fixed to a stationary axle.

Hence, a speed-up two-speed planetary transmission, a speed-down two-speed planetary transmission, and three-speed planetary transmission can selectively be obtained. A speed-up two-speed planetary transmission can for example be obtained by only including the first clutch module. The speed-down two-speed planetary transmission can for example be obtained by only including the second clutch module. The three-speed planetary transmission can for example be obtained by including both the first clutch module and the second clutch module.

The first clutch module may be configured for selectively being in a first state or a second state, wherein, in the first state, the first actuatable clutch is closed such that torque can be transferred through the first actuatable clutch from the planetary transmission input to the first one of the rotational members and the first freewheel is overrun; and in the second state, the first actuatable clutch is open such that no torque can be transferred through the first actuatable clutch, and the first freewheel transfers torque from the planetary transmission input to the second one of the rotational members.

The second clutch module may be configured for selectively being in a third state or a fourth state, wherein in the third state, the second actuatable clutch is closed such that torque can be transferred from the second one of the rotational members to the planetary transmission output, and the second freewheel is overrun; and wherein in the fourth state, the second actuatable clutch is open such that no torque can be transferred through the second actuatable clutch, and the second freewheel transfers torque from the first one of the rotational members to the planetary transmission output.

With the first clutch module or the second clutch module, the transmission system is selectively operable according to two different transmission ratios. With the first clutch module and the second clutch module, the transmission system is selectively operable according to three different transmission ratios. The first clutch module and the second clutch module can be switched between their respective states, e.g. by, e.g. electric, actuation of the first actuatable clutch and the second actuatable clutch respectively. The first actuatable clutch and the second actuatable clutch may particularly be independently actuatable.

Optionally, the transmission system may comprise a first electric actuator arranged for actuating the first actuatable clutch, and a second electric actuator arranged for actuating the second actuatable clutch.

The first freewheel and the second freewheel may be passive mechanisms that are not actuatable. A freewheel is overrun when its output rotates faster than its input, e.g. each freewheel is configured to disengage its driving input from its driven output when its driven output rotates faster than is driving input. The first freewheel is overrun in the first state, hence allowing the first and the second one of the rotational members to rotate at different speeds. The second freewheel is overrun in the third state.

The first actuatable clutch is arranged for selectively coupling or decoupling the planetary transmission input to the first one of the rotational members having a lower rotational speed than the second one of the rotational members. Hence, in the first state, when the first one of the rotational members is driven via the first actuatable clutch, the first freewheel is overrun, while in the second state, when the second one of the rotational member is driven via the freewheel, the first one of the rotational members is decoupled by the first actuatable clutch from the planetary transmission input.

The planetary transmission may have at most three rotational planetary gear set members. One of the rotational members is fixed to the stationary part, e.g. a stationary axle or housing part. The first clutch module selectively couples the planetary transmission input to one of the nonfixed rotational members. The second clutch module selectively couples the planetary transmission output to one of the non-fixed rotational members.

The at most three planetary gear set members can include a sun gear, a planet carrier carrying one or more planet gears, and a ring gear. The at most three planetary gear set members can include a single-diameter sun gear, a planet carrier carrying one or more planet gears, and a single-diameter ring gear. The at most three planetary gear set members can include only one sun gear, only one planet carrier carrying one or more planet gears, and only one ring gear. Alternatively, the at most three planetary gear set members can include two sun gears and a planet carrier carrying one or more planet gears. Alternatively, the at most three planetary gear set members can include two ring gears and a planet carrier carrying one or more planet gears. The planetary transmission may be selectively operable according to at least two, such as two or three, different transmission ratios between a planetary transmission input and a planetary transmission output. The first clutch module is connected or connectable to the planetary transmission input and configured for selectively transferring torque from the planetary transmission input to the first one or the second one of the three rotational members. The second clutch module is connected or connectable to the planetary transmission output and configured for selectively transferring torque from the first one or the second one of the three rotational members to the three-speed planetary transmission output.

The bicycle transmission system can switch between two different transmission ratios using one clutch module, e.g. only the first clutch module or only the second clutch module.

The bicycle transmission system can switch between three different transmission ratios, using two actuatable clutches, e.g. the first clutch module and the second clutch module.

The transmission system including the first clutch module and the second clutch module particularly allows for changing from one system transmission ratio directly to any other system transmission ratio in one step, i.e. without having to go through an intermediate system transmission ratio. For example, the planetary transmission can be operable according to a first transmission ratio, a second transmission ratio, and a third transmission ratio, using the first and second actuatable clutches accordingly. The planetary transmission can be shifted directly between any of the three transmission ratios, e.g. directly from the first to the second and vice versa, directly from the first to the third and vice versa, and directly from the second to the third and vice versa.

The transmission system can for example be housed by a hub shell of a driven wheel of the bicycle, and shielded by the hub shell from the environment. When for example combined with a cassette of sprockets and an associated derailleur for shifting a chain between the sprockets of the cassette, a hybrid bicycle transmission can be obtained with a large transmission ratio range and convenient transmission ratio steps between successive transmission ratios.

The first actuatable clutch and the second actuatable clutch may for example each be electrically controlled and independently actuated between a respective coupled state and a decoupled state. Each clutch module may hence be selectively in one of only two states. Combined, the first clutch module and the second clutch module may be selectively in one of four states, e.g. associated with the first clutch being closed and the second clutch being closed; the first clutch being open and the second clutch being closed; the first clutch being closed and the second clutch being open; the first clutch being open and the second clutch being open.

Optionally, the first one of the rotational members is a planet carrier carrying one or more planet gears. Optionally, the second one of the rotational members is a ring gear. Optionally, the third one of the rotational members is a sun gear. The first one of the rotational members can be a planet carrier, the second one of the rotational members can be a single-diameter ring gear, and the third one of the rotational members can be a single-diameter sun gear. Hence, the first clutch module may be connected or connectable to the three-speed planetary transmission input and configured for selectively transferring torque from the three-speed planetary transmission input to the planet carrier or the ring gear.

Optionally, the one or more planet gears of the planetary transmission are stepped planet gears including a large-radius gear part and a small-radius gear part rotationally fixed to each other. This allows for obtaining a relatively large transmission ratio with a relatively compact setup.

Optionally, the stepped planet gear includes two, e.g. identical, small-radius gears parts rotationally fixed to the large-radius gear part on opposite sides of the large-radius gear part. A symmetric planet gear can hence be obtained, enabling effective support for the stepped planet gear. The large-radius gear part may for example mesh with the ring gear, such that torque can be transferred from the planet carrier to the ring gear via the large-radius planet gear part, wherein the two small-radius planet gear parts on opposing sides of the large-radius planet gear part for example mesh with respective sun gear parts of the single-diameter sun gear. A robust yet compact setup can hence be obtained.

Optionally, the first actuatable clutch is actuatable between a coupled state associated with the first state and a decoupled state associated with the second state, and in the coupled state configured for rotationally coupling the three-speed planetary transmission input to the first one of the rotational members, and in the decoupled state rotationally decoupling the three-speed planetary transmission input from the first one of the rotational members. Hence, with two states of the first actuatable clutch module, the three-speed planetary transmission input can be coupled to one of the rotational members of planetary gear set of the three-speed planetary transmission. The first actuatable clutch module may for example be connected in series with the first one of the rotational members. The first actuatable clutch module may for example be connected in series with the, e.g. single-diameter, planet carrier.

Optionally, the first clutch module includes a third freewheel in a transmission path between the planetary transmission input and the first actuatable clutch or in a transmission path between the first actuatable clutch and the first one of the rotational members.

Optionally, the planetary transmission is selectively operable according to a unitary transmission ratio. Optionally, if the planetary transmission includes the first clutch module and the second clutch module, the planetary transmission operates according to the unitary transmission ratio when the first actuatable clutch is closed and the second actuatable clutch is open and/or when the first actuatable clutch is open and the second actuatable clutch is closed. Optionally, if the planetary transmission includes the first clutch module and not the second clutch module, the planetary transmission operates according to the unitary transmission ratio when the first actuatable clutch is closed and according to a nonunitary transmission ratio when the first actuatable clutch is open, or vice versa. Optionally, if the planetary transmission includes the second clutch module and not the first clutch module, the planetary transmission operates according to the unitary transmission ratio when the second actuatable clutch is open and according to a nonunitary transmission ratio when the second actuatable clutch is closed, or vice versa.

Optionally, the planetary transmission ratio is selectively operable according to a speed-increasing transmission ratio. Optionally, if the planetary transmission includes the first clutch module and the second clutch module, the planetary transmission operates according to the speed-increasing transmission ratio when the first actuatable clutch is closed and the second actuatable clutch is closed. Optionally, if the planetary transmission includes the first clutch module and not the second clutch module, the planetary transmission operates according to the speed-increasing transmission ratio when the first actuatable clutch is open.

Optionally, the planetary transmission is selectively operable according to a speed-decreasing transmission ratio. Optionally, the speed-increasing transmission ratio and the speed-decreasing transmission ratio are inverse to each other. Optionally, if the planetary transmission includes the first clutch module and the second clutch module, the planetary transmission operates according to the speed-decreasing transmission ratio when the first actuatable clutch is open and the second actuatable clutch is open. Optionally, if the planetary transmission includes the second clutch module and not the first clutch module, the planetary transmission operates according to the speed-increasing transmission ratio when the first actuatable clutch is open.

Optionally, the second clutch module is actuatable between a coupled state associated with the third state and a decoupled state associated with the fourth state, and in the coupled state configured for rotationally coupling the planetary transmission output to the second one of the rotational members, and in the decoupled state rotationally decoupling the planetary transmission output from the second one of the rotational members. Hence, with two states of the second actuatable clutch, the planetary transmission output can be coupled to one of the rotational members of the planetary transmission. The second actuatable clutch may for example be connected in series with the second one of the rotational members. The second actuatable clutch may for example be connected in series with the, e.g. single-diameter, ring gear.

Optionally, the planetary transmission includes a fourth freewheel in a transmission path between the second one of the rotational members and the second actuatable clutch or in a transmission path between the second actuatable clutch and the planetary transmission output. The third freewheel and/or the fourth freewheel allows the bicycle to be rolled backwards, preventing a lockup of the three-speed planetary transmission.

Optionally, the first actuatable clutch and the second actuatable clutch are identical. A manufacturing cost benefit can hence be obtained, as the transmission system may require only a single type of actuatable clutch that can be produced in large numbers.

Optionally, the planetary transmission is selectively operable according to a unitary transmission ratio, a speed-increasing transmission ratio and a speed-decreasing transmission ratio. The speed-increasing transmission ratio and the speed-decreasing transmission ratio may particularly be inverse to each other.

Optionally, the transmission system comprises a hub shell, e.g. an outer hub shell, for a driven wheel of the bicycle, delimiting, at least in part, a hub cavity, wherein the planetary transmission is housed by the hub shell in the hub cavity.

Optionally, the transmission system, further comprising an inner hub shell configured for being received in the hub cavity and being removably coupled to the, e.g. outer, hub shell for transmitting torque from the inner hub shell to the, e.g. outer, hub shell. The planetary transmission may be housed inside the inner hub shell and coupled to the inner hub shell for being removable, along with the inner hub shell, from the, e.g. outer, hub shell

Optionally, the transmission system comprises a further planetary transmission having three further rotational members. The further planetary transmission may also comprise a third clutch module and/or a fourth clutch module. The third clutch module may include a third actuatable clutch in a transmission path between a further planetary transmission input and a first one of the further rotational members, and a fifth freewheel in a transmission path between the further planetary transmission input and a second one of the further rotational members. The fourth clutch module may include a fourth actuatable clutch in a transmission path between the second one of the further rotational members and a further planetary transmission output, and a sixth freewheel in a transmission path between the first one of the further rotational members and the further planetary transmission output. A third one of the further rotational members may be non-rotatably fixed to the stationary axle.

Hence, also with the further planetary transmission a speed-up two-speed planetary transmission, a speed-down two-speed planetary transmission, and a three-speed planetary transmission can selectively be obtained. Combining the further planetary transmission with the planetary transmission may increase the number of transmission ratios for the transmission system. The combination of the planetary transmission with the further planetary transmission may for example provide a four-speed, six-speed and/or nine-speed transmission system.

The transmission ratios obtainable with the transmission system that includes the planetary transmission and the further planetary transmission can be selected using the first clutch module and/or the second clutch module, and the third clutch module and/or the fourth clutch module. Each of the actuatable clutches of the transmission system may be independently actuatable, for example using separate electric actuators.

The third clutch module may be configured for selectively being in a fifth state or a sixth state, wherein, in the fifth state, the third actuatable clutch is closed such that torque can be transferred through the third actuatable clutch from the further planetary transmission input to the first one of the further rotational members and the fifth freewheel is overrun; and in the sixth state, the third actuatable clutch is open such that no torque can be transferred through the third actuatable clutch, and the fifth freewheel transfers torque from the further planetary transmission input to the second one of the further rotational members.

The fourth clutch module may be configured for selectively being in a seventh state or an eighth state, wherein in the seventh state, the fourth actuatable clutch is closed such that torque can be transferred from the second one of the further rotational members to the further planetary transmission output, and the sixth freewheel is overrun; and wherein in the eighth state, the fourth actuatable clutch is open such that no torque can be transferred through the fourth actuatable clutch, and the sixth freewheel transfers torque from the first one of the further rotational members to the further planetary transmission output.

Optionally, the further planetary transmission is connected in series to the planetary transmission.

Optionally, the planetary transmission input is connected or connectable to the further planetary transmission output. Optionally, the planetary transmission output is connected or connectable to the further planetary transmission input.

Optionally, the planetary transmission is a two-speed planetary transmission and the further planetary transmission is a three-speed planetary transmission, providing a six-speed planetary transmission system. Optionally, the planetary transmission is a two-speed planetary transmission and the further planetary transmission is a two-speed planetary transmission, providing a four-speed planetary transmission system. Optionally, the planetary transmission is a three-speed planetary transmission and the further planetary transmission is a two-speed planetary transmission, providing a six-speed planetary transmission system. Optionally, the planetary transmission is a three-speed planetary transmission and the further planetary transmission is a three-speed planetary transmission, providing a nine-speed planetary transmission system.

Optionally, if the planetary transmission is a three-speed planetary transmission and the further planetary transmission is a two-speed planetary transmission, the three-speed planetary transmission input may be connected or connectable to the two-speed planetary transmission output. It may be desirable to have the two-speed planetary transmission at an input side of the three-speed transmission, for example to reduce the torque on the three-speed planetary transmission.

Optionally, the further planetary transmission includes at most three further rotational planetary gear set members. The further planetary transmission can include a further sun gear, a further planet carrier carrying one or more further planet gears, and a further ring gear. The at most three further planetary gear set members can include a single-diameter further sun gear, a further planet carrier carrying one or more planet gears, and a single-diameter further ring gear. The at most three further planetary gear set members can include only one further sun gear, only one planet carrier carrying one or more planet gears, and only one further ring gear. Optionally, at least one of the further sun gear, further planet carrier, and further ring gear is rotationally fixed or fixable to the stationary part.

Optionally, the further sun gear of the further planetary transmission is rotationally fixed or fixable to the stationary part.

Optionally, the further planetary gear set of the further planetary transmission is a sunless planetary gear set with only one planet carrier carrying one or more planet gears, and two ring gears. Optionally, the only one planet carrier is rotationally fixed to the stationary part.

Optionally, the further planetary gear set of the further planetary transmission is a ringless planetary gear set with only one planet carrier carrying one or more planet gears, and two sun gears. Optionally, the only one planet carrier is rotationally fixed to the stationary part.

Optionally, the further sun gear, the one or more further planet gears and the further ring gear of the three-speed planetary transmission are identical in diameter to respectively the sun gear, the one or more planet gears and the ring gear of the two-speed planetary transmission. The rotational members of the further planetary transmission and the planetary transmission can for example be identical, providing a manufacturing cost benefit.

Optionally, at least one of the rotational members of the further planetary transmission, differs in diameter from a respective rotational member of the planetary transmission.

Optionally, the third actuatable clutch module is actuatable between a coupled state associated with the third state and a decoupled state associated with the fourth state, and in the coupled state configured for rotationally coupling the two-speed planetary transmission input to the planet carrier of the further planetary transmission, and in the decoupled state rotationally decoupling the further planetary transmission input from the planet carrier of the two-speed planetary transmission.

Optionally, the third clutch module includes a seventh freewheel in a transmission path between the further planetary transmission input and the third actuatable clutch or between the third actuatable clutch and the first one of the further rotational members.

Optionally, the fourth clutch module includes an eighth freewheel in a transmission path between the further planetary transmission input and the fourth actuatable clutch or between the fourth actuatable clutch and the second one of the further rotational members.

Optionally, the third actuatable clutch is identical to the fourth actuatable clutch.

Optionally, the third actuatable clutch and the fourth actuatable clutch are identical to the first actuatable clutch and the second actuatable clutch.

Optionally, the further planetary transmission is selectively operable according to a unitary transmission ratio. Optionally, the further planetary transmission is selectively operable according to a speed-increasing transmission ratio. The speed-increasing transmission ratio may increase a further planetary transmission output speed relative to a further planetary transmission input speed by a factor of at least 1.5, preferably at least 2, such as by a factor in a range of about 2 to 3. Hence, a large transmission ratio range can be obtained for the transmission system, wherein the two-speed planetary transmission substantially contributes to the range and the three-speed planetary transmission substantially contributes to the intermediate transmission ratio steps within the range.

Optionally, the speed-increasing transmission ratio of the further planetary transmission is about equal to a speed-increasing transmission ratio of the planetary transmission cubed, or wherein a speed-increasing transmission ratio of the further planetary transmission is about equal to the cube-root of a speed-increasing transmission ratio of the planetary transmission. A nine-speed planetary transmission can for example be obtained, with substantially equal steps between the successive transmission ratios of the nine transmission ratios. For example, the planetary transmission may provide three transmission ratios: R1, R2 and R3, wherein R3 is equal to the inverse of R1, and wherein R2 is equal to one. The further planetary transmission may for example provide three transmission ratios: R4, R5 and R6, wherein R4 is equal to R1 cubed, R5 is equal to one, and R6 is equal to R4 inverse. R1 may particularly be chosen to correspond to a desired step size between successive transmission ratios.

Optionally, the bicycle transmission system comprises a hub shell for a driven wheel of the bicycle, wherein the further planetary transmission is housed by the hub shell. A hub transmission can hence be obtained, wherein the further planetary transmission can be shielded by the hub shell from the environment. The planetary transmission and the further planetary transmission may be housed by a common hub shell. For example, the planetary transmission may be held by a first cavity and the further planetary transmission may be held by a second cavity, the first and second cavities being, at least in part, delimited by the hub shell. The first and second cavities may for example be parts of a single hub cavity, formed by the hub shell.

Optionally, the transmission system comprises a continuously variable transmission (CVT) connected in series with the planetary transmission and/or the further planetary transmission, the continuously variable transmission being selectively operable according to a plurality of different transmission ratios within a continuous CVT range. The CVT may be similar to the CVT as disclosed in co-pending patent application PCT/EP1022/060920, which is incorporated by reference in its entirety.

Optionally, the CVT is controlled to selectively operate according to a transmission ratio within a finite set of predetermined transmission ratios. Said finite set of predetermined transmission ratios is a subset of the theoretical infinite set of transmission ratios defined by the continuous range of transmission ratios obtainable by the CVT. The CVT can be controlled to switch between transmission ratios of the predetermined finite set of transmission ratios, e.g. between a predetermined first CVT transmission ratio and a predetermined second CVT transmission ratio, etc. The finite set of transmission ratios may for instance include at most eleven different transmission ratios, such as at most five different transmission ratios. Hence, the CVT may be used as a discrete transmission, i.e. having discrete transmission ratios.

Optionally, the finite set of transmission ratios is (pre)programmable by a user. Hence, the discrete transmission ratio steps of the CVT may be (pre)programmably adaptable.

Optionally, the CVT is releasably couplable to the planetary transmission and/or to the further planetary transmission.

Optionally, an output of the CVT is connected or connectable to an input of the planetary transmission and/or the further planetary transmission.

Optionally, the transmission system comprises comprising an offset drive having a set of sprockets and an endless drive member, such as a chain or belt, configured for engaging a sprocket of the set of sprockets, and a driver configured for being rotationally connected to the set of sprockets, wherein the offset drive is connected in series with the planetary transmission.

Optionally, the driver is rotationally integrated with the CVT, such as with the CVT input.

Optionally, the continuously variable transmission includes a first drive element rotatable about a first axis; a second drive element rotatable about a second axis, the first drive element being movable relative to the second drive element in a direction transverse to the first and second axis; coupling elements provided at a constant first radius from the first axis and at a variable second radius from the second axis, or at a constant first radius from the second axis and at a variable second radius from the first axis, for transferring torque between the first drive element and the second drive element. The coupling elements are provided for transferring torque between the first drive element and the second drive element. The first drive element and the second drive element are movable relative to each other in a direction transverse to the first and second axis for transferring torque at different transmission ratios. By varying the relative displacement between the first drive element being associated with the first axis, and the second drive element being associated with the second axis, the variable second radius at which torque is transferred between the first and second drive elements is varied. Hence, various transmission ratios can be obtained between the first and second drive elements. Hence, various transmission ratios can be obtained between an input and an output of the CVT. The CVT can be made into a relative small form factor, with a relatively few components and small mass.

The first drive element may be connected to a driver which is configured for receiving a set of sprockets. The second drive element may be connected to the three-speed planetary transmission, the two-speed planetary transmission and/or the hub shell.

Optionally, the coupling elements are coupled to the second drive element in a tangential direction, and movable relative to the second drive element in a radial direction. Thus, the coupling elements can move radially relative to the second axis, while remaining tangentially coupled to the second drive element. Optionally, the coupling elements are coupled to the first drive element in a radial direction at the first radius from the first axis, and movable relative to the first drive element in a first tangential direction. Optionally, the coupling elements are couplable to the first drive element in a second tangential direction opposite the first tangential direction. Thus, the coupling elements can be maintained at a predetermined radial distance relative to the first axis. The coupling elements can e.g. be freely movable in the first tangential direction relative to the first drive member and couple to the first drive element in the second tangential direction relative to the first drive member. Hence, the first drive element can drive the coupling elements in rotation in the first tangential direction, and the first drive element can freely move in the second tangential direction relative to the coupling elements. Also, the coupling elements can drive the first drive element in rotation in the second tangential direction, and the coupling elements can freely move in the first tangential direction relative to the first drive element.

Optionally, the first drive element is pivotally movable about a pivot axis that extends parallel to the first axis, for being pivotally moved relative to the second drive element in a direction transverse to the first axis.

Optionally, the first drive element comprises a first concentric guide extending concentrically around the first axis, wherein the first concentric guide is arranged for guiding a movement of the coupling elements in the first tangential direction. The first concentric guide may for example be a slot provided in the first drive element, which slot concentrically extends around the first axis.

Optionally, the first concentric guide and the coupling elements form or include a one-way coupling for allowing movement of the coupling elements relative to the first concentric guide in the first tangential direction, and for blocking movement of the coupling elements relative to the first concentric guide in the second tangential direction. Each of the coupling elements may for example comprise a one-way unit which is arranged to be wedged between an inner race and an outer race of the first concentric guide when driven in the second tangential direction.

Optionally, each of the coupling elements comprises a wedging body which is tiltable about a tilt axis between a neutral position in which free movement of the coupling element relative to the first concentric guide is allowed, and a wedged position in which the wedging body is wedgingly engaged with the first concentric guide. For example the wedging body may be wedged between two races of the first concentric guide, e.g. between in inner race and an outer race. It will be appreciated that the neutral position and the wedged position may differ only slightly, e.g. a few micrometers at the extreme points. For assuming the neutral position it is sufficient that the wedging body is no longer wedgingly engaged with the first concentric guide.

Optionally each of the coupling elements comprises at least one roller for activating the tilting of the wedging body from the neutral position to the wedged position.

Optionally, a first end of the wedging body is provided with a converging wedging recess for cooperating with a first roller and a second end of the wedging body, opposite the first end, is provided with a diverging wedging recess for cooperating with a second roller. Here converging and diverging are defined as seen in a direction away from the centre of the wedging body. With respect to a freewheel direction of the wedging bodies, the converging wedging recess may be provided at a leading end of the wedging bodies, and the diverging recess may be provided at a trailing end of the wedging bodies. The first roller may for example be provided between an inner race of the first concentric guide and a converging wedging face of the converging wedging recess. The second roller may for example be provided between an outer race of the first concentric guide and a diverging wedging face of the diverging wedging recess. Optionally, the first and/or the second roller is biased, e.g. elastically, e.g. with a spring, in a wedging direction. The first and/or the second roller can be biased towards the converging side of the wedging recesses. This provides the advantage that the wedging body is biased in a wedged state, and can be released by movement in the freewheel direction.

Optionally, the second drive element comprises first radial guides extending at least radially with respect to the second axis, i.e. having a radial component. The first radial guides are arranged for guiding movement of the coupling elements in radial direction and for transmitting torque in tangential direction. The first radial guides may comprise radially extending slots in a body of the second drive element.

Optionally, each of the coupling elements comprises a guide wheel for running along the first radial guides.

Optionally, the coupling elements are movably, such as hingedly, connected to the second drive element for allowing a radial movement of the coupling elements relative to the second drive element.

Optionally, each wedging body is tiltable about a tilt axis between a neutral position in which free movement of the coupling element relative to the first concentric guide is allowed, and a wedged position in which each wedging body is wedgingly engaged with the first concentric guide.

Optionally, each of the coupling elements comprises two wedging bodies. Optionally, each wedging body of the first coupling element is tiltable about a common tilt axis between a neutral position in which free movement of the coupling element relative to the first concentric guide is allowed, and a wedged position in which each wedging body is wedgingly engaged with the first concentric guide.

Optionally, the guide wheel is rotatable about the common tilt axis, wherein the two wedging bodies are arranged on either side of the guide wheel.

Optionally, the transmission is arranged for pivoting the first drive element about the pivot axis between a first extreme position and a second extreme position, e.g. between a concentric position in which the first axis coincides with the second axis and an eccentric position in which the first axis is offset from the second axis.

Optionally, the first drive element is pivotable about the pivot axis to a selective position within a continuous pivot range defined between the first extreme position and the second extreme position, e.g. between the concentric position and the eccentric position, wherein the continuous pivot range is symmetrical with respect to a horizontal plane through the pivot axis.

Optionally, the transmission system comprises an, e.g. stationary, axle having a first axle part and a second axle part, wherein the CVT is associated with the first axle part, and the three-speed planetary transmission is associated with the second axle part, wherein the first axle part and the second axle part are detachably connected to each other.

Optionally, any of the actuatable clutches described herein is/are arranged for coupling and/or decoupling under load. For instance, each of the actuatable clutches described herein is/are arranged for coupling and/or decoupling under load. Any of the clutches described herein may for example be a form-closed clutch.

Optionally, the first actuatable clutch and the second actuatable clutch are form closed clutches, configured for transferring torque in two rotation directions

For any or each of the actuatable clutches, it holds that, optionally, the actuatable clutch has a clutch input, and a clutch output, the actuatable clutch including:
a first unit connectable to the clutch input, including at least one first abutment surface;
a second unit connectable to the clutch output, including at least one second abutment surface arranged for selectively engaging the first abutment surface, the first and second abutment surfaces being adapted to each other so as to allow disengaging under load, preferably in two directions;
a third unit including at least one retaining member, the third unit being arranged for selectively being in a first mode or a second mode relative to the second unit, wherein the at least one retaining member in the first mode locks the at least one second abutment surface for rotationally coupling the second unit to the first unit, e.g. in two directions, and in the second mode releases the at least one second abutment surface for decoupling the second unit from the first unit. The transmission system including such actuatable clutch module (or actuatable clutch modules) can be manufactured in a small form-factor suitable for integration in a two-wheeled bicycle.

Optionally, the actuatable clutch module includes an actuator for moving the third unit from a first position to a second position or from a second position to a first position relative to the second rotatable unit.

Optionally, the third unit includes at least one actuation member arranged for moving the third unit from a first position to a second position or from a second position to a first position relative to the second rotatable unit.

Optionally, the actuatable clutch further includes a fourth unit including a selector, the selector being arranged for selectively being in a gripping or non-gripping mode,
the selector in the gripping mode being arranged for gripping the at least one actuation member for rotating the third rotatable unit from the first position to the second position or from the second position to the first position relative to the second rotatable unit;
the selector in the non-gripping mode being arranged for not engaging the at least one actuation member

Optionally, the actuatable clutch module includes a first rotatable unit connectable to the input; a second rotatable unit connectable to the output; a third rotatable unit arranged for co-rotating with the second rotatable unit, the third rotatable unit being arranged for selectively being in a first rotational position or a second rotational position relative to the second rotatable unit, wherein the module is arranged for selectively in the first rotational position rotationally coupling the second rotatable unit to the first rotatable unit, and in the second rotational position decoupling the second rotatable unit from the first rotatable unit; wherein the module is arranged for temporarily changing rotation speed of the third rotatable unit relative to the second rotatable unit for rotating from the first position to the second position, or from the second position to the first position.

Optionally, the actuatable clutch module further comprises a fourth unit including a selector, the selector being arranged for selectively being in a gripping or non-gripping mode; the selector in the gripping mode being arranged for gripping the at least one actuation member for rotating the third rotatable unit from the first position to the second position or from the second position to the first position relative to the second rotatable unit; the selector in the non-gripping mode being arranged for not engaging the at least one actuation member.

Any actuatable clutch module may or example be similar or identical to a clutch as described in WO1018/199757A2, WO1020/085911A2, or WO1021/080431A1, incorporated herein by reference in their entirety. For instance, each actuatable clutch module may or example be similar or identical to a clutch as described in WO1018/199757A2, WO1020/085911A2, or WO1021/080431A1.

According to an aspect, a modular bicycle transmission system is provided. The modular bicycle transmission comprises a housing delimiting a first cavity and a second cavity. The first cavity selectively holds an exchangeable first transmission module or an exchangeable first bridging element. The second cavity selectively holds an exchangeable second transmission module or an exchangeable second bridging element. Various different setups can hence be obtained, by selecting appropriate exchangeable transmission modules and/or exchangeable bridging elements. When no transmission module is to be held by the first or second cavity, said cavity may or may not hold a bridging element instead to bridge the space of said cavity. The exchangeable bridging element can transfer torque across the cavity it is provided in. The modular transmission system may for example include the first exchangeable transmission module in the first cavity, wherein the second exchangeable bridging element is held by the second cavity to transfer torque from the first exchangeable transmission module across the second cavity, e.g. to an output of the modular transmission module. The first cavity may be associated with an input of the modular transmission system and the second cavity may be associated with an output of the modular transmission system. Alternatively, the first cavity may be associated with an output of the modular transmission system and the second cavity may be associated with an input of the modular transmission system.

The exchangeable first transmission module may have an input connectable to an input of the modular transmission system, and an output connectable to the exchangeable second transmission module or the exchangeable second bridging element. The exchangeable first bridging element may have an input connectable to an input of the modular transmission system, and an output connectable to the exchangeable second transmission module or the exchangeable second bridging element. The exchangeable second transmission module may have an output connectable to an output of the modular transmission system, and an input connectable to the exchangeable first transmission module or the exchangeable first bridging element. The exchangeable second bridging element may have an output connectable to an output of the modular transmission system, and an input connectable to the exchangeable first transmission module or the exchangeable first bridging element. The housing of the modular transmission system may particularly be formed by a hub shell of a driven wheel of the bicycle.

The first cavity may for example hold the first exchangeable transmission module when the second cavity holds the second exchangeable transmission module. The first cavity may for example hold the first bridging element when the second cavity holds the second exchangeable transmission module. The first cavity may for example hold the first exchangeable transmission module when the second cavity holds the second bridging element. The first cavity may for example hold the first bridging element when the second cavity may holds the second bridging element.

Optionally, the exchangeable first transmission module includes a planetary transmission, such as the planetary transmission described herein or the further planetary transmission described herein. Optionally, the exchangeable second transmission module includes a planetary transmission, such as the planetary transmission described herein or the further planetary transmission described herein.

Optionally, the exchangeable first transmission module includes a three-speed planetary transmission, or a two-speed planetary transmission. It will be appreciated that the three-speed planetary transmission or the two-speed planetary transmission can be a transmission as described herein.

Optionally, the exchangeable second transmission module includes a three-speed planetary transmission, or a two-speed planetary transmission. It will be appreciated that the three-speed planetary transmission or the two-speed planetary transmission can be a transmission as described herein.

Optionally the first cavity holds the three-speed planetary transmission and the second cavity holds the second bridging element; or
the first cavity holds the first bridging element and the second cavity holds the three-speed planetary transmission; or
the first cavity holds the two-speed planetary transmission and the second cavity holds the second bridging element; or
the first cavity holds the first bridging element and the second cavity holds the two-speed planetary transmission; or
the first cavity holds the three-speed planetary transmission and the second cavity holds another of said three-speed planetary transmission; or
the first cavity holds the two-speed planetary transmission and the second cavity holds another of said two-speed planetary transmission; or
the first cavity holds the three-speed planetary transmission and the second cavity holds the two-speed planetary transmission; or
the first cavity holds the two-speed planetary transmission and the second cavity holds the three-speed planetary transmission; or
the first cavity holds the first bridging element and the second cavity holds the second bridging element.

Optionally, a CVT, such as the CVT described herein, is held by the first cavity and/or the second cavity. For example, optionally, the first cavity holds the three-speed planetary transmission and the second cavity holds the CVT; or
the first cavity holds the CVT and the second cavity holds the three-speed planetary transmission; or
the first cavity holds the two-speed planetary transmission and the second cavity holds the CVT; or
the first cavity holds the CVT and the second cavity holds the two-speed planetary transmission; or
the first cavity holds the first bridging element and the second cavity holds the CVT; or
the first cavity holds the CVT and the second cavity holds the second bridging element.

Optionally, the bicycle transmission system comprises an electric propulsion motor for propelling, or at least assist in propelling, the bicycle, wherein the electric propulsion motor is held by the first cavity and/or the second cavity. For example, optionally, the first cavity holds the three-speed planetary transmission and the second cavity holds the electric propulsion motor; or
the first cavity holds the electric propulsion motor and the second cavity holds a three-speed planetary transmission; or
the first cavity holds a two-speed planetary transmission and the second cavity holds the electric propulsion motor; or
the first cavity holds the electric propulsion motor and the second cavity holds a two-speed planetary transmission; or
the first cavity holds the first bridging element and the second cavity holds the electric propulsion motor; or
the first cavity holds the electric propulsion motor and the second cavity holds the second bridging element.

Optionally, the bicycle transmission system comprises a generator configured for converting motive power of one or more moving parts of the bicycle transmission system to electric power. The generator may be held by the first cavity and/or the second cavity. The generator may be separate from the electric propulsion motor. Alternatively, the generator may be integrated with the electric propulsion motor. Electric power generated by the generator may be used for powering one or more electric actuators, such as one or more electric shift actuators for shifting gears of the three-speed and/or two-speed planetary transmission.

Optionally, the housing is formed by a hub shell for a driven wheel of the bicycle. Optionally, the housing is formed by a crank transmission housing.

Optionally, the modular transmission system comprises an exchangeable driver module configured for being mounted to a set of sprockets, wherein the exchangeable driver module is arranged external to the first cavity and the second cavity, and releasably connectable to the exchangeable first transmission module and/or the exchangeable second transmission module. The modular transmission system can hence be selectively expanded with a driver module. The driver module may carry a set of sprockets, i.e. one or more sprockets, for engaging an endless drive member such as a chain or belt. A desired driver may be selected to be connected to the first and/or second exchangeable transmission module, e.g. a driver that is arranged to carry a desired number of sprockets. By adding the driver module, the range and/or number of transmission ratios obtainable with the modular transmission system may hence be increased.

Optionally, the driver module includes the continuously variable transmission (CVT) as described herein. For example, the driver module may comprise a driver for being mounted to the set of sprockets. The driver may be rotatable about the first axis, and the housing of the modular transmission system can be rotatable about the second axis parallel to the first axis. Optionally, the first drive element of the CVT is connected to the driver and rotatable about the first axis, and the second drive element of the CVT is connected to the housing and rotatable about the second axis.

Optionally, the modular transmission system comprises an antenna module having an antenna for receiving a wirelessly transmitted signal, wherein the antenna is arranged external to the housing. The antenna can for example be configured to receive a wireless shift signal for effecting a gear change with the modular transmission system. The location of the antenna external to the housing enables a substantially unconstructed reception of the wirelessly transmitted signal. Alternatively the antenna may be housed by the housing, e.g. in the first cavity and/or the second cavity. The housing may in that case include an antenna window to improve the reception of the antenna. The antenna window may for example be more permeable for the wirelessly transmitted signal than other parts of the housing surrounding or adjacent to the antenna window. The housing may for example be substantially made of a metal, whereas the antenna window is made of a nonmetallic material.

Optionally, the antenna module comprises a wired connection path extending from the antenna to a connector site within the first cavity and/or the second cavity, for connection to an actuator of the exchangeable first transmission module and/or the exchangeable second transmission module. The antenna module may for instance include a printed circuit board (pcb), forming the wired connection path from the antenna to the connector site.

Optionally, the modular transmission system comprises a stationary axle about which the hub shell is rotatably arranged, and wherein the antenna module is fixed, or fixable, to the stationary axle such that the antenna is arranged, in axial direction of the axle, between the hub shell and an end of the stationary axle.

Optionally, the wired connection path extends, in radial direction, between the axle and a bearing.

The antenna module as described herein may be part of the bicycle transmission system as described herein, but it will be appreciated that the antenna module may be used for other bicycle transmission systems as well. Hence, an aspects provides an antenna module, such as described herein. The antenna module comprises an antenna for receiving a wirelessly transmitted signal. The antenna module may comprise a wired connection path extending from the antenna to a connection site for connecting an, e.g. electric, actuator, such as a shift actuator. The antenna module may be arranged to be mounted to a wheel axle about which a hub shell is rotatably arranged, such that the antenna is arranged external to a hub shell and the connection site is arranged internal to the hub shell. The antenna may in use be arranged, in axial direction of the axle, between the hub shell and a dropout of the bicycle frame.

According to an aspect, a nine-speed planetary bicycle transmission system is provided, comprising a first three-speed planetary transmission selectively operable according to three different first transmission ratios and a second three-speed planetary transmission selectively operable according to three different second transmission ratios, wherein the first three-speed planetary transmission and the second three-speed planetary transmission are connected to each other in series. It will be appreciated that the three-speed planetary transmissions can be transmissions as described herein.

Optionally, the first transmission ratios includes a unitary transmission ratio, and/or wherein the second transmission ratios includes a unitary transmission ratio.

Optionally, the first transmission ratios includes a speed-increasing transmission ratio and a speed-decreasing transmission ratio, and/or wherein the second transmission ratios includes a speed-increasing transmission ratio and a speed-decreasing transmission ratio.

Optionally, one of the first transmission ratios is a nonunitary transmission ratio that is about equal to one of the second transmission ratios cubed, or one of the first transmission ratios is nonunitary transmission ratio that is about equal to the cube-root of one of the second transmission ratios.

Optionally, the first three-speed planetary transmission comprises a first clutch module and a second clutch module cooperatively configured for selectively operating the first three-speed planetary transmission according to the three different first transmission ratios; and the second three-speed planetary transmission comprises a third clutch module and fourth clutch module cooperatively configured for selectively operating the second three-speed planetary transmission according to the three different second transmission ratios.

Optionally, the first three-speed planetary transmission has three first rotational members, and the second three-speed planetary transmission has three second rotational member, a third one of said first rotational members and a third one of the second rotational members being non-rotatably fixed to a stationary part, wherein the first clutch module includes a first actuatable clutch in a transmission path between the first three-speed planetary transmission input and a first one of the first rotational members, and a first freewheel in a transmission path between the first three-speed planetary transmission input and a second one of the first rotational members, the second clutch module includes a second actuatable clutch in a transmission path between the second one of the first rotational members and a first three-speed planetary transmission output, and a second freewheel in a transmission path between the first one of the first rotational members and the first three-speed planetary transmission output, the third clutch module includes a third actuatable clutch in a transmission path between a second three-speed planetary transmission input and a first one of the second rotational members, and a fifth freewheel in a transmission path between the second three-speed planetary transmission input and a second one of the second rotational members, the fourth clutch module including a fourth actuatable clutch in a transmission path between the second one of the second rotational members and a second three-speed planetary transmission output, and a sixth freewheel in a transmission path between the first one of the second rotational members and the second three-speed planetary transmission output.

Optionally, the nine-speed planetary bicycle transmission comprises a third freewheel in a transmission path between the first three-speed planetary transmission input and the first actuatable clutch, or between the first actuatable clutch and the first one of the first rotational members; a fourth freewheel in a transmission path between the second one of the first rotational members and the second actuatable clutch or between the second actuatable clutch and the first three-speed planetary transmission output; a seventh freewheel in a transmission path between the second three-speed planetary transmission input and the third actuatable clutch or between the third actuatable clutch and the first one of the second rotational members; and/or an eighth freewheel in a transmission path between the second three-speed planetary transmission input and the fourth actuatable clutch or between the fourth actuatable clutch and the second one of the second rotational members.

Optionally, the nine-speed planetary bicycle transmission comprises a hub shell for a driven wheel of the bicycle, wherein first three-speed planetary transmission and the second three-speed planetary transmission are housed by the hub shell.

According to an aspect, a six-speed planetary bicycle transmission, comprising a three-speed planetary transmission selectively operable according to three different first transmission ratios and a two-speed planetary transmission selectively operable according to two different second transmission ratios, wherein the three-speed planetary transmission and the two-speed planetary transmission are connected to each other in series. It will be appreciated that the three-speed planetary transmission and/or the two-speed planetary transmission can be a transmission as described herein.

Optionally, the first transmission ratios includes a unitary transmission ratio, and/or wherein the second transmission ratios includes a unitary transmission ratio.

Optionally, the first transmission ratios includes a speed-increasing transmission ratio and a speed-decreasing transmission ratio, and/or wherein the second transmission ratios includes a speed-increasing transmission ratio or a speed-decreasing transmission ratio.

Optionally, the speed increasing transmission ratio of the second transmission ratios increases a two-speed planetary transmission output speed relative to a two-speed planetary transmission input speed by a factor of at least two.

Optionally, the speed increasing transmission ratio of the second transmission ratios is about equal to the speed-increasing ratio of the first transmission ratios cubed.

Optionally, the three-speed planetary transmission comprises a first clutch module and a second clutch module cooperatively configured for selectively operating the three-speed planetary transmission according to the three different first transmission ratios; and the two-speed planetary transmission comprises a third clutch module configured for selectively operating the two-speed planetary transmission according to the two different second transmission ratios.

Optionally, the three-speed planetary transmission has three first rotational members, and the two-speed planetary transmission has three second rotational member, a third one of the first rotational members and a third one of the second rotational members being non-rotatably fixed to a stationary part, wherein the first clutch module includes a first actuatable clutch in a transmission path between the three-speed planetary transmission input and a first one of the first rotational members, and a first freewheel in a transmission path between the three-speed planetary transmission input and a second one of the first rotational members, the second clutch module includes a second actuatable clutch in a transmission path between the second one of the first rotational members and the six-speed planetary transmission output, and a second freewheel in a transmission path between the first one of the first rotational members and the six-speed planetary transmission output, and the third clutch module includes a third actuatable clutch in a transmission path between a two-speed planetary transmission input and a first one of the second rotational members, and a fifth freewheel in a transmission path between the two-speed planetary transmission input and a second one of the second rotational members.

Optionally, the six-speed planetary bicycle transmission comprises a third freewheel in a transmission path between the three-speed planetary transmission input and the first actuatable clutch, or between the first actuatable clutch and the first one of the first rotational members; a fourth freewheel in a transmission path between the second one of the first rotational members and the second actuatable clutch or between the second actuatable clutch and the three-speed planetary transmission output; a seventh freewheel in a transmission path between the two-speed planetary transmission input and the third actuatable clutch or between the third actuatable clutch and the first one of the second rotational members.

Optionally, the six-speed planetary bicycle transmission comprises a hub shell for a driven wheel of the bicycle, wherein three-speed planetary transmission and the two-speed planetary transmission are housed by the hub shell.

According to a further aspect, a bicycle is provided, comprising a transmission system as described herein. It will be appreciated that a bicycle encompasses similar human-powered vehicles, particularly pedal-powered, such as tricycles, quadricycles, etc. The transmission system may be embodied as a hub transmission of the bicycle and/or as a crank transmission of the bicycle.

According to an aspect, an electrically powered vehicle is provided, such as a light electrically powered vehicle for example an electrically powered bicycle or scooter. The electrically powered vehicle comprises an electric propulsion motor having an output power of maximum 10 kW, preferably maximum 4 kW; the electric propulsion motor being arranged for driving a driven wheel of the vehicle, wherein a bicycle transmission system as described herein is arranged in a transmission path between the electric propulsion motor and the driven wheel.

It will be appreciated that any of the aspects, features and options described herein can be combined. It will particularly be appreciated that any of the aspects, features and options described in view of the bicycle transmission system apply equally to the modular bicycle transmission system, and vice versa.

### BRIEF DESCRIPTION OF THE DRAWINGS

Embodiments of the present invention will now be described in detail with reference to the accompanying drawings in which:

FIGS. 1-15 show schematic examples of a bicycle transmission system; and

FIG. 16 shows a bicycle.

### DETAILED DESCRIPTION

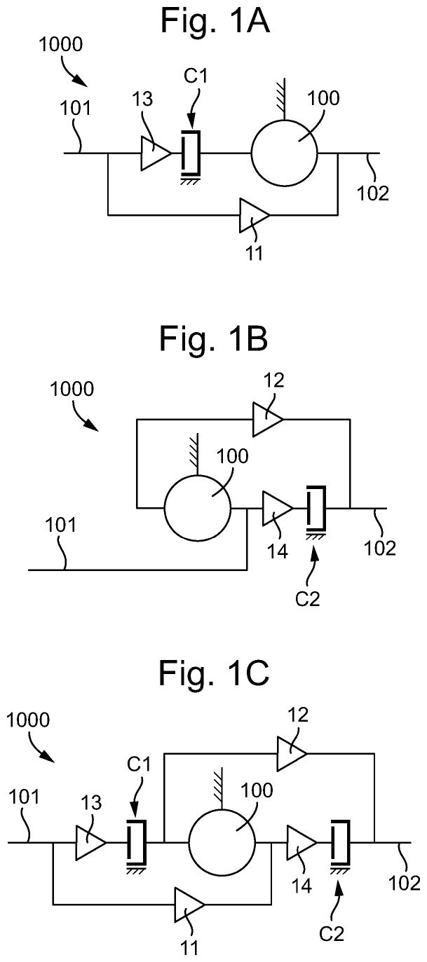

FIGS. 1A-1C schematically show respective examples of a planetary transmission 1000. Each planetary transmission 1000 includes a planetary gear set 100 with three rotational members such as a sun gear, a planet carrier carrying one or more planet gears, and a ring gear. FIGS. 1A and 1B show examples of a two speed planetary transmission 1000. FIG. 1C shows an example of a three-speed planetary transmission.

FIG. 1A shows a two-speed planetary transmission 1000 to include a first clutch module that includes a first actuatable clutch C1 and a first freewheel 11. The first clutch module is arranged at an input side of the planetary gear set 100. The first actuatable clutch C1 is here arranged between the planetary transmission input 101 and a first one of the rotational members, here the planet carrier. The first freewheel is arranged in a parallel transmission path between the planetary transmission input 101 and a second one of the rotational members, here the ring gear. The second one of the rotational members, here the ring gear, is connected or integrated the planetary transmission output 102. The first clutch module here also includes an optional third freewheel 13. The third freewheel 13 is arranged in series with the first actuatable clutch, here at an input side of the clutch 13.

When the first actuatable clutch is closed, i.e. in a coupled state, torque can be transmitted from the input 101 to the first one of the rotational members, here the planet carrier, via the clutch C1. The first one of the rotational members transfers, here the planet carrier, the torque to the second one of the rotational members, here the ring gear, according to a predefined transmission ratio. Here, the transmission ratio is a speed-increasing transmission ratio. Hence, the first freewheel 11 can be overrun, when the first clutch C1 is closed. When the clutch C1 is open, i.e. in a decoupled state, no torque can be transmitted via the first clutch C1 from the input 101 to the first one of the rotational members. Instead, when the first clutch C1 is open, torque can be transmitted from the input 101 to the second one of the rotational members, here the ring gear, via the first freewheel 11. The exemplary planetary transmission of FIG. 1A is accordingly selectively operable according to unitary transmission ratio and a speed-increasing transmission ratio. By actuating the first clutch C1, i.e. open and closing the first clutch C1, the transmission system 1000 can be controlled to operate according to the unitary or the speed-increasing transmission ratio.

FIG. 1B shows a two-speed planetary transmission 1000 to include a second clutch module that includes a second actuatable clutch C2 and a second freewheel 12. The second clutch module is arranged at an output side of the planetary gear set 100. The second actuatable clutch C2 is here arranged between the planetary transmission output 102 and a second one of the rotational members, here the ring gear. The second freewheel 12 is arranged in a parallel transmission path between the planetary transmission output 102 and a first one of the rotational members, here the planet carrier. The second clutch module here also includes an optional fourth freewheel 14. The fourth freewheel 14 is arranged in series with the second actuatable clutch C2, here at an input side of the clutch 14.

When the second actuatable clutch C2 is closed, i.e. in a coupled state, torque can be transmitted from the input 101, via the second one of the rotational members, here the ring gear, and via the clutch C2, to the output 102. The second one of the rotational members, here the ring gear, also drives the first one of the rotational members, here the planet carrier, in rotation according to a predefined transmission ratio. Here, the transmission ratio is a speed-decreasing transmission ratio. Hence, the second freewheel 12 can be overrun, when the first clutch C1 is closed. When the second clutch C2 is open, i.e. in a decoupled state, no torque can be transmitted via the second clutch C2. Instead, when the second clutch C2 is open, torque can be transmitted from the input 101 via the planetary gear set 100, and via the second freewheel 12, to the output 102. The exemplary planetary transmission of FIG. 1B is accordingly selectively operable according to unitary transmission ratio and a speed-decreasing transmission ratio. By actuating the second clutch C2, i.e. open and closing the second clutch C2, the transmission system 1000 can be controlled to operate according to the unitary or the speed-decreasing transmission ratio.

FIG. 1C shows the transmission system 1000 to include the first clutch module and the second clutch module as shown in FIGS. 1A and 1B. The exemplary planetary transmission of FIG. 1C is accordingly selectively operable according to three different transmission ratios, here a speed-decreasing transmission ratio, a unitary transmission ratio, and a speed-increasing transmission ratio. The speed-increasing and the speed-decreasing transmission ratios may be inverse to one another.

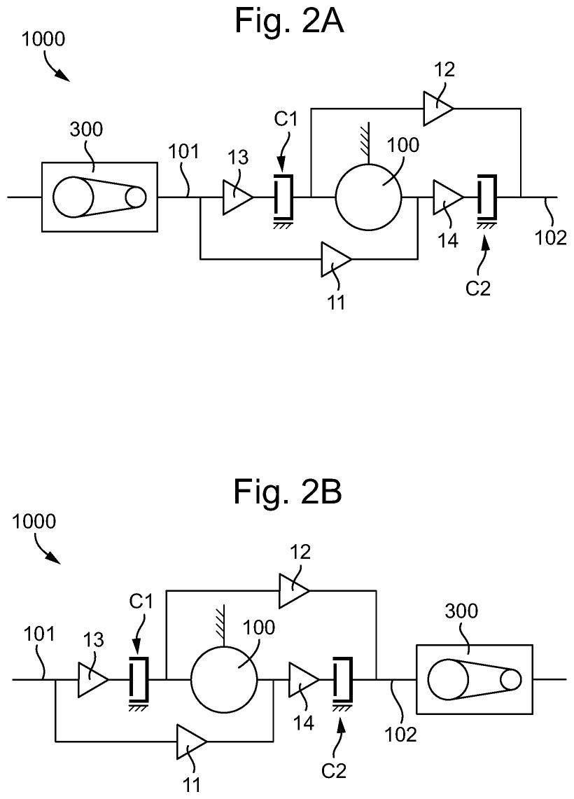

FIGS. 2A-B shows an example of a bicycle transmission system 1000 as shown in FIG. 1C, further including an offset drive 300. The offset drive includes an endless drive member, such as a chain, belt or cardan, that meshes with a front chain wheel connected to a crank, and a rear sprocket connected to a driven wheel. The offset drive 300 optionally includes a derailleur for shifting the endless drive member between differently sized sprockets and/or chain wheels. In the example of FIG. 2A, the offset drive 300 is arranged at an input side of the planetary transmission. The planetary transmission can hence form a hub transmission. In the example of FIG. 2B, the offset drive 300 is arranged at an output side of the planetary transmission. The planetary transmission can hence form a crank transmission.

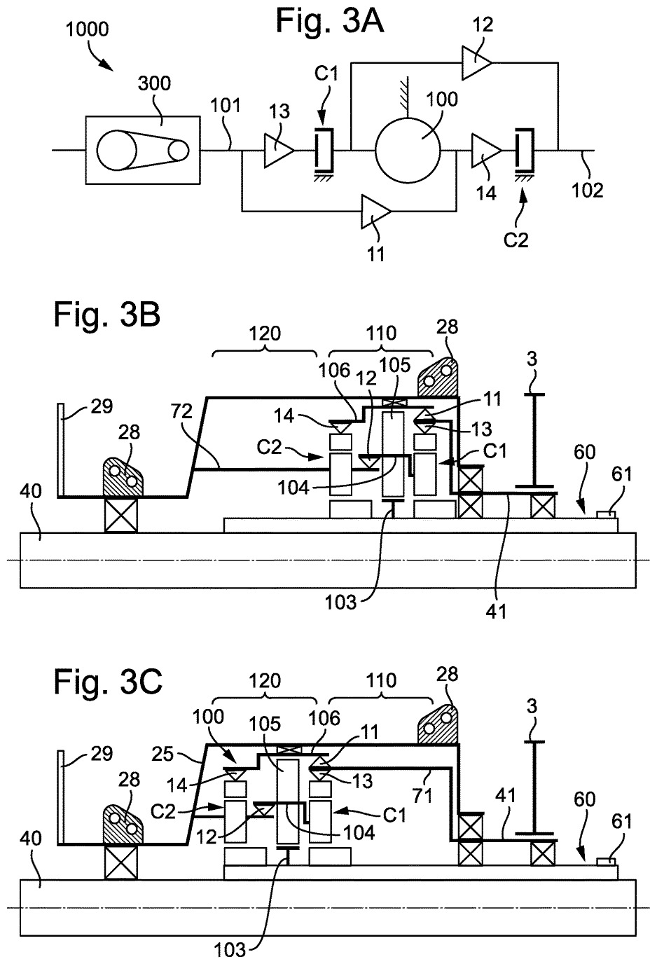

FIGS. 3A-3C schematically show an example of a bicycle transmission system 1000, comprising a three-speed planetary transmission 100. The three-speed planetary transmission has three rotational members, namely a sun gear 103, a planet carrier 104, and a ring gear 106. The planet carrier 104 carries one or more planet gears 105. The three-speed planetary transmission particularly has only one, single-diameter, sun gear 103, only one planet carrier 104, and only one, single-diameter, ring gear 106. In this example, the only one sun gear 103 is permanently rotationally fixed to a stationary axle 40. The three-speed planetary transmission is selectively operable according to three different transmission ratios between a three-speed planetary transmission input 101 and a three-speed planetary transmission output 102, by means of a first actuatable clutch C1 and a second actuatable clutch C2.

The first clutch module is associated with the three-speed planetary transmission input 101 and configured for selectively transferring torque from said three-speed planetary transmission input 101 to one of the rotational members. Here, first actuatable clutch C1 is connected between the three-speed planetary transmission input 101 and the planet carrier 104. In a coupled state of the first actuatable clutch C1, the first actuatable clutch transfers torque from the planetary transmission input to the planet carrier 104, while in a decoupled state of the first actuatable clutch C1, the first actuatable clutch C1 decouples the planetary transmission input from the planet carrier 104.

The three-speed planetary transmission also comprises a first freewheel 11, connected between the planetary transmission input and the ring gear 106. The first freewheel 11 is overrun when the first actuatable clutch is in the coupled state, enabling the ring gear 106 to rotate faster than the planet carrier 104. The first freewheel 11 transfers torque from the planetary transmission input to the ring gear 106, when the first actuatable clutch C1 is in the decoupled state.

The second clutch module is associated with the three-speed planetary transmission output 102 and configured for selectively transferring torque from one of the three rotational members to said three-speed planetary transmission output 102. Here, the second actuatable clutch C2 is connected between the ring gear 106 and the three-speed planetary transmission output 102. In a coupled state of the second actuatable clutch C2, the second actuatable clutch C2 transfers torque from the ring gear 106 to the planetary transmission output, while in a decoupled state of the second actuatable clutch C2, the second actuatable clutch C2 decouples the ring gear 106 from the planetary transmission output.

The second actuatable clutch C2 is in this example identical to the first actuatable clutch C1.

The three-speed planetary transmission also comprises a second freewheel 12, connected between the planet carrier 104 and the planetary transmission output 102. The second freewheel 12 is overrun when the second actuatable clutch C2 is in the coupled state, enabling the ring gear 106 to rotate faster than the planet carrier 104. The freewheel transfers torque from the planet carrier 104 to the planetary transmission output 102, when the first actuatable clutch C1 is in the decoupled state.

FIGS. 3A-3C show the transmission system 1000 further including an offset drive 300, such as a chain drive, cardan drive, or belt drive. The offset drive 300 may provide a, e.g. nonunitary, transmission ratio from a crank of the bicycle, driven by a user, to a rear sprocket 3. The rear sprocket 3 is here connected to the three-speed planetary transmission input 101, in this example via a driver 41. The rear sprocket 3 may be part of a set of sprockets 3. In the example of FIGS. 3A-3C, the transmission system 1000 includes only one sprocket 3, but it will be appreciated that a set of multiple differently sized sprockets 3 may be provided. A conventional derailleur can for instance be used for selecting a, any, desired sprocket 3, e.g. by shifting the chain, belt or cardan.

The three-speed planetary transmission output 102 is in this example coupled to a hub shell 25 of a driven wheel of the bicycle. The hub shell 25 is provide with spoke flanges 28 for attaching spokes of the driven wheel. The hub shell 25 is also couplable to a brake disc 29. The hub shell 25 here delimits, at least in part, a cavity. The hub shell 25 particularly delimits, at least in part, a first cavity 110 and a second cavity 120. In this example, the first cavity 110 and the second cavity 120 are part of a single cavity. In the example of FIG. 3B, the three-speed planetary transmission is arranged in the first cavity 110. The second cavity 120 holds a second bridging element 72. The second bridging element 72, here, transfers torque from the three-speed planetary transmission output 102 to the hub shell 25. The second bridging element 72, here, bridges the second cavity 120 to transfer torque across the second cavity 120. In the example of FIG. 3C, the three-speed planetary transmission is arranged in the second cavity 120. The first cavity 110 holds a first bridging element 71. The first bridging element 71, here, transfers torque from the driver 41 to the three-speed planetary transmission input 101. The first bridging element 71, here, bridges the first cavity 110 to transfer torque across the first cavity 110.

The three-speed planetary transmission in this example includes a third freewheel 13 between the three-speed planetary transmission input 101 and the first actuatable clutch C1. Alternatively, the third freewheel 13 can be arranged between the first actuatable clutch C1 and the planet carrier 104. The three-speed planetary transmission also includes a fourth freewheel 14 in this example, arranged between the ring gear 106 and the second actuatable clutch C2. Alternatively, the fourth freewheel 14 can be arranged between the ring gear 106 and the three-speed planetary transmission output 102. The third and/or fourth freewheel 13, 14 prevent lockup of the three-speed planetary transmission when the bicycle is rolled backwards.

It will be appreciated that a freewheel as described herein is configured to disengage its driving input from its driven output when the driven output rotates faster than the driving input.

The first actuatable clutch C1 and the second actuatable clutch C2 are in this example electrically actuatable between their respective coupled and decoupled state. Hereto, the bicycle transmission system 1000 includes an antenna module 60, comprising an antenna 61 for receiving a wirelessly transmitted shift signal. The shift signal may for example be received from a shifter unit by which a user can command a gear shift with the transmission system 1000. The antenna module 60 here also comprises a wired connection path 62 between the antenna 61 and a connection site for connecting each of the clutches of the transmission system 1000. The clutches may be actuated in accordance win the received shift signal. The clutches may be so controlled to obtain the appropriate transmission ratio for the three-speed planetary transmission, in accordance with the received shift signal.

The antenna module 60 is here arranged for being fixed to the stationary axle 40. The antenna 61 is in this example arranged external to the hub cavity, wherein the wired connection extends from the antenna 61 to the clutches within the hub cavity. The antenna module 60 is this example arranged, in axial direction, between the driver 41 and an end portion of the axle 40 where the axle 40 is to be mounted to a drop out of a frame of the bicycle. Hence, in use, the antenna 61 is arranged in this example, in axial direction, between the bicycle frame dropout and the driver 41.

The antenna 61 may alternatively be provided within the hub cavity. To allow a wireless signal, such as electromagnetic signals such as radio waves, to reach the antenna 61, at least with sufficient power to be properly received by the antenna 61, the hub shell 25 may be at least partially permeable to the wireless signal, in particular part of the hub shell 25 surrounding the antenna 61 may be permeable to the wireless signal. For example, a part of the hub shell 25 may form a window which is more permeable to the wireless signal than other parts of the hub shell 25 surrounding or adjacent to said window. In particular when the hub shell 25 is at least partially permeable to the wireless signal another part of the hub shell 25 may comprise electromagnetic shielding material, such as metal. Such electromagnetic shielding material may be used to provide strength and/or stiffness to the hub shell 25, and may be more suited to provide said strength and/or stiffness compared to materials which are more permeable to electromagnetic radiation.

With the exemplary planetary transmission system 1000 as shown in FIGS. 3A-C, exemplary transmission ratios can be obtained as shows in table 1 below, using the first actuatable clutch C1 and the second actuatable clutch C2.

TABLE 1

| | C1 | C2 | Ratio |
|---|---|---|---|
| 1 | decoupled | decoupled | 0.76 |
| 2 | decoupled | coupled | 1 |
| 2 | coupled | decoupled | 1 |
| 3 | coupled | coupled | 1.32 |

Here, the first transmission ratio and the third transmission ratios are inverse to each other.

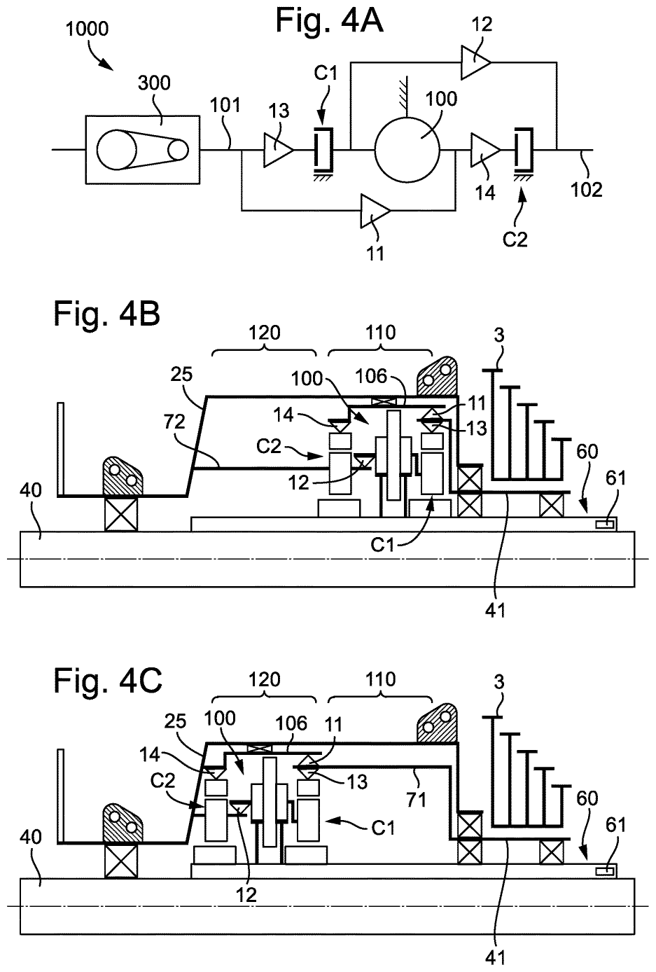

FIGS. 4A-C shows another example of a three-speed planetary transmission, similar to the example as shown in FIGS. 3A-C. Here, the planet gear 105 is a stepped planet gear 105. The stepped planet gear 105 comprises a large-radius part and a small-radius part. Here, the small-radius part meshes with the sun gear 103, while the large-radius part meshes with the gear 106. Each planet gear 105 particularly includes two small-radius parts arranged on either side of the large-radius part, to obtain a substantially symmetric planet gear 105. Here the single-diameter sun gear 103 is split into two sun gear parts. The small-radius gear parts mesh with respective sun gear parts of the single-diameter sun gear 103. The sun gear parts can hence provide a symmetric support for the planet gear 2105. The sun gear 103 is in this example fixed to the stationary axle 40.

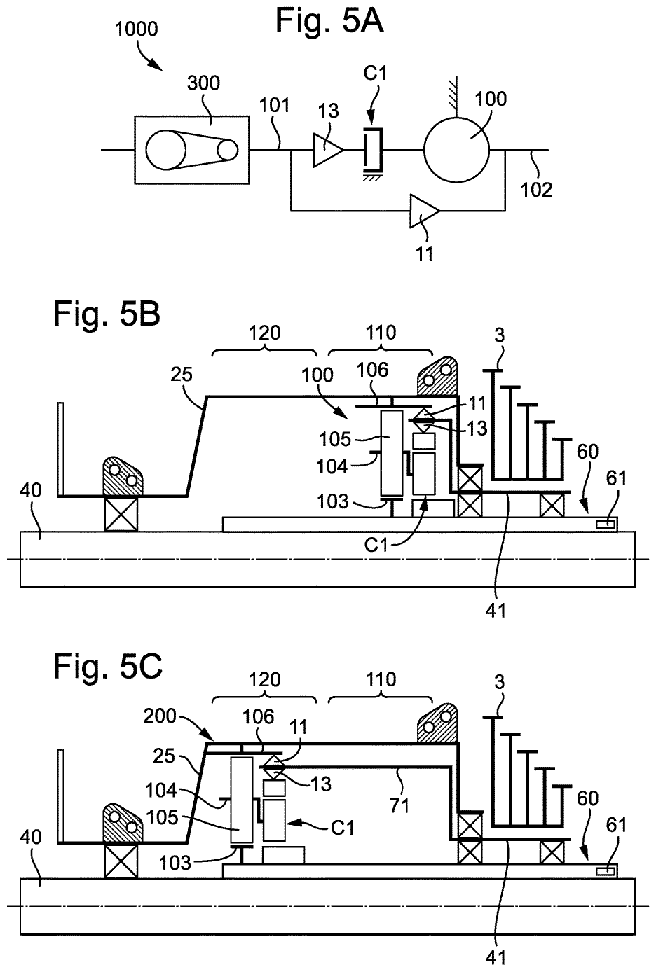

FIGS. 5A-5C show an example of the bicycle transmission system 1000 comprising a two-speed planetary transmission, similar to as described in view of FIG. 1A. In the example of FIG. 5B, the two-speed planetary transmission is arranged in the first hub shell cavity 110. The second hub shell 120 cavity holds a second bridging element 72, bridging the second cavity 120 to transfer torque from the two-speed planetary transmission output 102 to the hub shell 25. In the example of FIG. 5C, the two-speed planetary transmission is arranged in the second cavity 120. The first cavity 110 holds a first bridging element 71, bridging the first cavity 110 to transfer torque from the driver 41 to the two-speed planetary transmission input 101. In the example of FIG. 5A, the second one of the rotational members, here the ring gear 106, is directly coupled to the hub shell 25. Hence, no second bridging element 72 may be needed here.

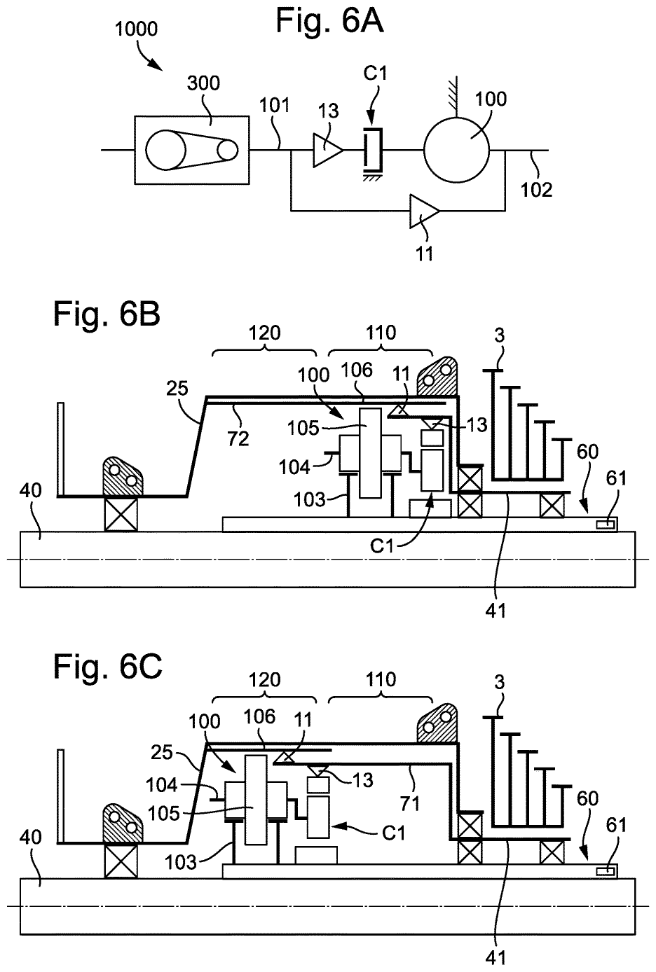

FIGS. 6A-6C show an example of the bicycle transmission system 1000 with a two-speed planetary transmission, similar to the example of FIGS. 5A-C. Here the two-speed planetary transmission comprises a single-diameter sun gear 103, only one planet carrier 104, carrying one or more planet gears 105, and a single-diameter ring gear 106. Each planet gear 105 is here a stepped planet gear, comprising a large-radius part and a small-radius part. Here, the small-radius part meshes with the sun gear 103, while the large-radius part meshes with the gear 106. Each planet gear 105 particularly includes two small-radius parts arranged on either side of the large-radius part, to obtain a substantially symmetric planet gear 105. Here the single-diameter sun gear 103 is split into two sun gear parts. The small-radius gear parts mesh with respective sun gear parts of the single-diameter sun gear 103. The sun gear parts can hence provide a symmetric support for the planet gear 105. The sun gear 103 is in this example fixed to the stationary axle 40.

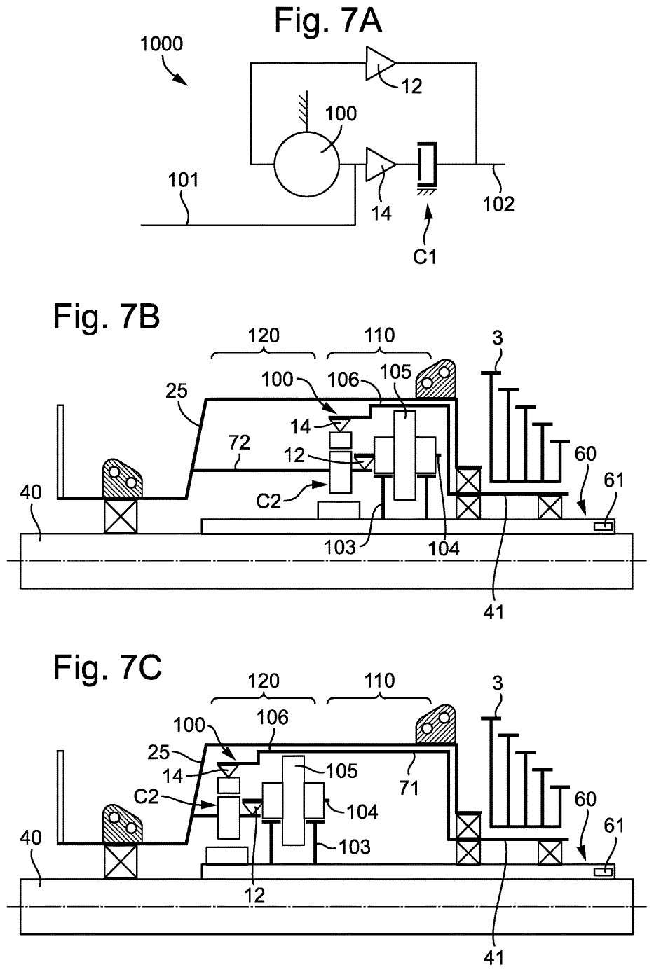

FIGS. 7A-C show an example of the bicycle transmission system 1000 with a two-speed planetary transmission similar to the example of FIG. 1B. Here, the planetary transmission includes the second clutch module and not the first clutch module. In this example, the planetary gear set includes a stepped planet gear 105 and a single split sun gear 103, similar as the example of FIGS. 4A-C. In the example of FIG. 7B, the two-speed planetary transmission is arranged in the first hub shell cavity 110, while the second hub shell 120 cavity holds a second bridging element 72, bridging the second cavity 120 to transfer torque from the two-speed planetary transmission output 102 to the hub shell 25. In the example of FIG. 7C, the two-speed planetary transmission is arranged in the second cavity 120, while the first cavity 110 holds a first bridging element 71, bridging the first cavity 110 to transfer torque from the driver 41 to the two-speed planetary transmission input 102. In this example, the sprocket is part of a set of multiple sprockets. A derailleur may be provided for shifting a chain or belt from one sprocket of the set to another.

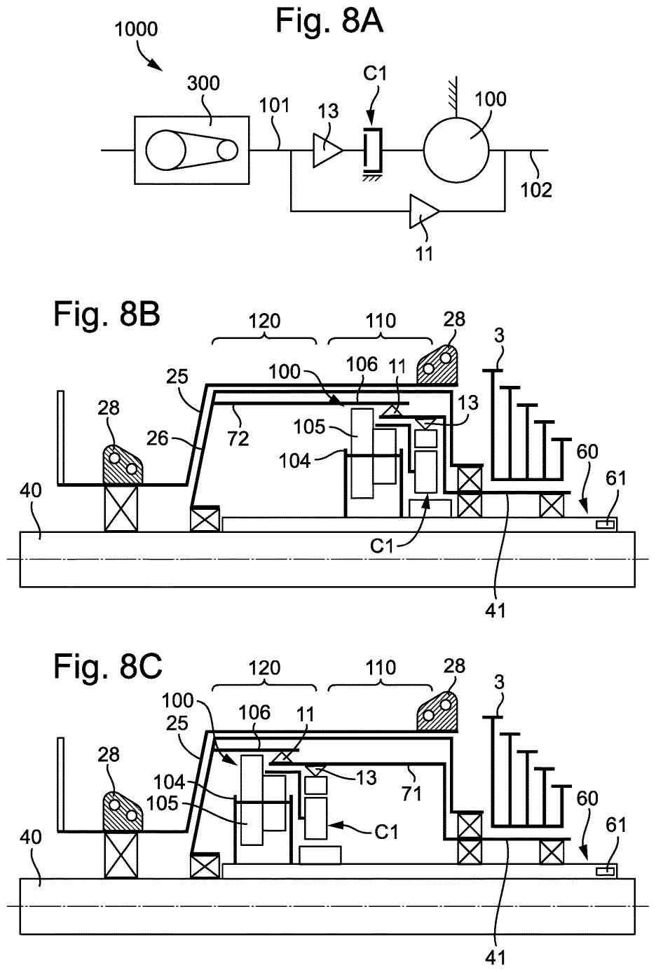

FIGS. 8A-8B schematically show an example of the bicycle transmission system 1000 comprising a two-speed planetary transmission. In this example, the two-speed planetary transmission is a sunless planetary transmission, comprising a planet carrier 104 carrying one or more planet gears 105, and a ring gear 106, here two ring gears 106a, 106b. Hence, in this example, the planetary gear set of the two-speed planetary transmission does not have a sun gear. In an alternative example, the planetary gear set of the two-speed planetary transmission may be ringless, comprising a planet carrier 104 carrying one or more planet gears 105 and a sun gear 103, e.g. two sun gears, and not comprising a ring gear.

The planet carrier 104 is fixedly mounted to the axle 40 in this example. Each planet gear 105 is a stepped planet gear in this example, having two rotationally coupled gear parts of different radii. Here, a small-radius part of the stepped planet gear 105 meshes with a first one of the ring gears 106a, e.g. an input ring gear 106a, whereas the large-radius part of the stepped planet gear 105 meshes with a second one of the ring gears 106b, e.g. an output ring gear 106b. Hence, in this example, the two-speed planetary gear transmission provides a nonunitary transmission ratio, here a speed-up transmission ratio. The two-speed planetary transmission further provides a unitary transmission ratio. The third actuatable clutch C3 enables switching between the two transmission ratios of the two-speed planetary transmission.

In the example of FIGS. 8A-B, the transmission system comprises an inner hub shell 26. The inner hub shell 26 is removably received in the hub shell cavity, and releasably couplable to the hub shell 25. The planetary transmission is held by the inner hub shell 26. The planetary transmission is hence removable from the hub shell 25, along with the inner hub shell 26. The inner hub shell 26 may be fixed or fixable to the driver 41. The hub shell 25, here forming an outer hub shell, is provided with spoke flanges 28, for connection to spokes of the drive wheel. It will be appreciated that the transmission system of other example may similarly include an inner hub shell 26.

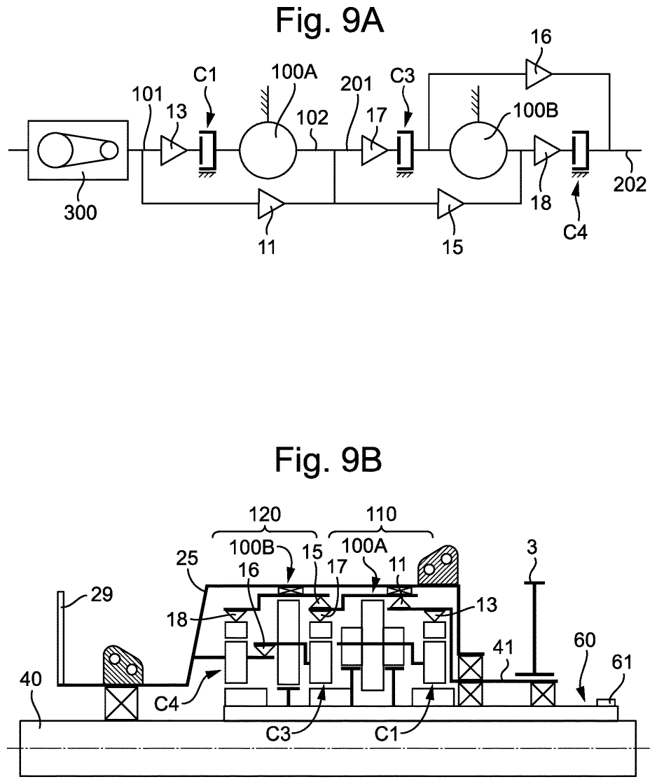

FIGS. 9A-9B schematically show an example of a bicycle transmission system 1000 comprising two planetary transmissions connected to each other in series. Here, the transmission system includes a three-speed planetary transmission and a two-speed planetary transmission. A six-speed planetary transmission system can hence be obtained. The two-speed and three-speed planetary transmission are housed by a common hub shell 25, in respectively the first cavity 110 and the second cavity 120. The two-speed planetary transmission output is in this example connected to the three-speed planetary transmission input. It will however be appreciated that the two-speed planetary transmission may alternatively be arranged at an output side of the three-speed planetary transmission.

Here, the planetary gear set 100A of the two-speed planetary transmission corresponds to the planetary gear set of the two-speed planetary transmission as shown and described in view of FIGS. 4A-C and 7A-C. The planetary gear set 100B of the three-speed planetary transmission corresponds to the planetary gear set of the three-speed planetary gear set as also shown and described in view of FIGS. 3A-C.

The two-speed planetary transmission includes the first clutch module with the first actuatable clutch C1, the first freewheel 11, and the third freewheel 13. The three-speed planetary transmission includes a third clutch module having a third actuatable clutch C3 a fifth freewheel 15 and an optional seventh freewheel 17. The third clutch module is similar to the first clutch module as described herein. The three-speed planetary transmission also includes a fourth clutch module including a fourth actuatable clutch C4, a sixth freewheel 16 and an optional eighth freewheel 18. The fourth clutch module is similar to the second clutch module as described herein.

Here, the two-speed planetary transmission is selectively operable according to unitary transmission ratio and a speed-increasing transmission ratio. Hence, in this example, by arranging the two-speed planetary transmission at the input side of the three-speed planetary transmission, a torque load on the three-speed planetary transmission can be minimized. The transmission system 1000 of FIGS. 9A-9B can be selectively operated according to six different transmission ratios. Hence, a six-speed transmission can be obtained, which is operated by only three clutches, namely the first actuatable clutch C1, the third actuatable clutch C3, and the fourth actuatable clutch C4. The first, third and fourth actuatable clutches C1, C3, C4 are here identical to each other. The first, third and fourth actuatable clutches C1, C3, C4 are moreover connected to each other in series.

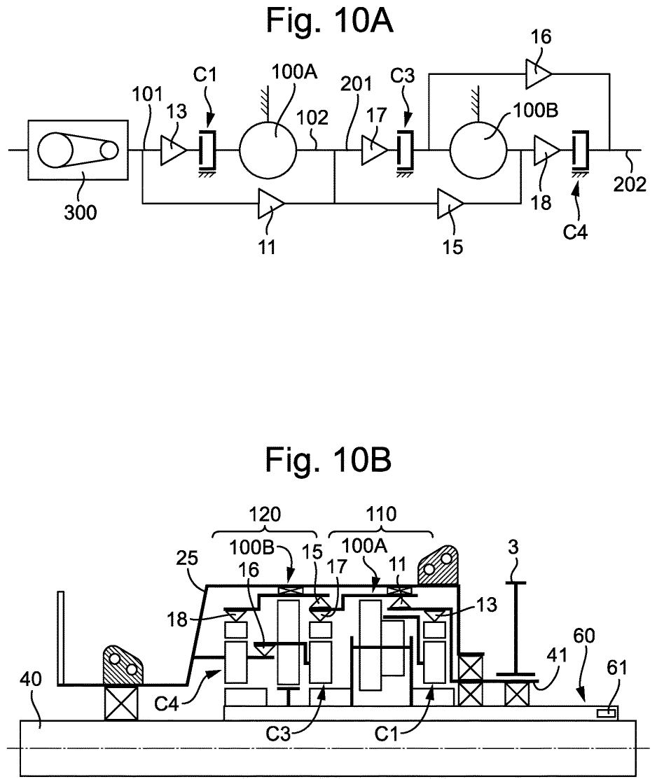

FIGS. 10A-10B schematically show another example of the bicycle transmission system 1000, comprising a two-speed planetary transmission in series with a three-speed planetary transmission. The two-speed and three-speed planetary transmissions are housed by the hub shell 25, in respectively the first cavity 110 and the second cavity 120. Here, the planetary gear set 100A of the two-speed planetary transmission is sunless, and corresponds to the planetary gear set of the two-speed planetary transmission as shown and described in view of FIGS. 8A-8C. The planetary gear set 100B of the three-speed planetary transmission corresponds to the planetary gear set of the three-speed planetary gear set as also shown and described in view of FIGS. 3A-C.

The six different transmission ratios of the exemplary six-speed bicycle transmission system 1000 of FIGS. 9A-9B and 10A-10B, may be selectively obtained by means of the first actuatable clutch C1, the third actuatable clutch C3, and the fourth actuatable clutch C4. For example, the three transmission ratios of the three-speed planetary transmission may be 0.76, 1.00 and 1.32, and the two transmission ratios of the two-speed planetary transmission may be 1.00 and 2.31. An exemplary six-speed transmission system 1000 that may be obtained, wherein the six transmission ratios are selectable using the first actuatable C1, third actuatable clutch C3, and the fourth actuatable clutch C4, is shown in table 2.

TABLE 2

| | C1 | C3 | C4 | Ratio |
|---|---|---|---|---|
| 1 | decoupled | decoupled | decoupled | 0.76 |
| 2 | decoupled | coupled | decoupled | 1 |
| 3 | coupled | coupled | decoupled | 1.32 |
| 4 | decoupled | decoupled | coupled | 1.76 |
| 5 | decoupled | coupled | coupled | 2.31 |
| 6 | coupled | coupled | coupled | 3.04 |

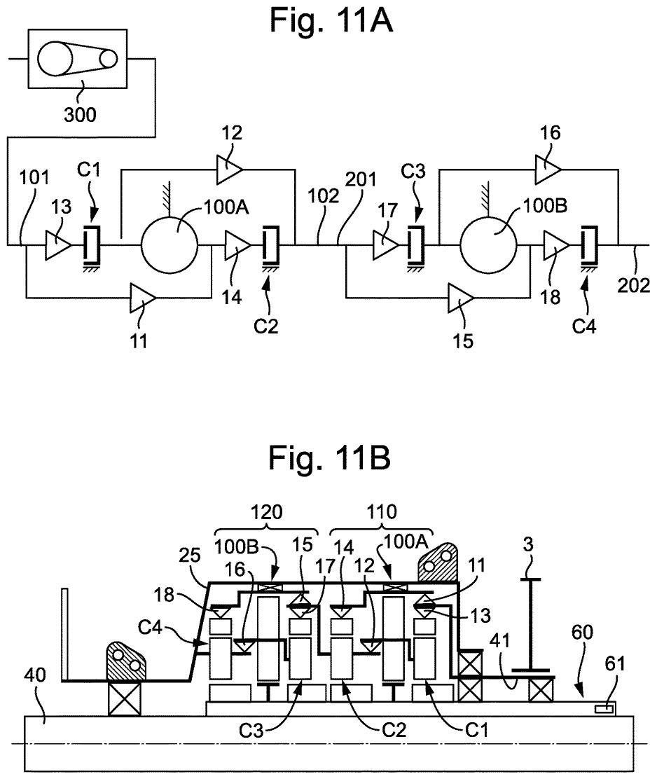

FIGS. 11A-11B schematically show an example of the bicycle transmission system 1000, comprising two three-speed planetary transmissions connected to each other in series. A nine-speed transmission system 1000 can hence be obtained.

A first one of the two three-speed planetary transmission includes the first clutch module with the first actuatable clutch C1, the first freewheel 11, and the optional third freewheel 13; and the second clutch module with the second actuatable clutch C2, the second freewheel 12, and the optional fourth freewheel 14. A second one of the three-speed planetary transmissions includes the third clutch module having the third actuatable clutch C3, the fifth freewheel 15 and the optional seventh freewheel 17; and the fourth clutch module with the fourth actuatable clutch C4, the sixth freewheel 16, and the optional eighth freewheel 18. The third clutch module is similar to the first clutch module as described herein. The fourth clutch module is similar to the second clutch module as described herein.

Any of the nine transmission ratios of the nine-speed transmission system 1000 can be selected using only four clutches C1, C2, C3, C4. Here the four clutches are identical to each other. The transmission system 1000 of this example hence includes four actuatable clutches C1, C2, C3, C4 in series. All of the clutches C1-C4 are, here, independently actuatable. Hence, the system can directly change from one transmission ratio to any other system transmission ratio, without having to go through intermediate transmission ratios. For example, the transmission system may change from a largest of the, here, nine transmission ratios directly to a smallest of the, here, nine transmission ratios, without having to go through any of the intermediate transmission ratios between the smallest and largest.

The transmission ratios of the respective planetary gear sets of the two three-speed planetary transmissions may be so chosen that a speed-increasing transmission ratio of one of the three-speed planetary transmissions is about equal to a speed-increasing transmission ratio of the other three-speed planetary transmission cubed. For example, the three-speed planetary transmission held by the first cavity provide three transmission ratios: R1, R2 and R3, wherein R3=1/R1, and wherein R2=1.00. The further planetary transmission may for example provide three transmission ratios: R4, R5 and R6, wherein R4=(R1)\hat{ }3, R5=1.00, and R6=1/R4. R1 may particularly be chosen as the appropriate step size between successive transmission ratios. If R1 is for example chosen as 1.14, giving a 14% step size, R3, R4 and R6 are calculated to be R3=0.88, R4=1.48, and R6=0.67. Using the clutches C1-C4, the exemplary nine transmission ratios can accordingly be obtained as shown in table 3.

TABLE 3

| | First cavity | | Second cavity | | | |
|---|---|---|---|---|---|---|
| | C1 | C2 | C3 | C4 | Ratio | Step |
| 1 | decoupled | decoupled | decoupled | decoupled | 0.59 | 1.14 |
| 2 | decoupled | coupled | decoupled | decoupled | 0.67 | 1.14 |
| 3 | coupled | coupled | decoupled | decoupled | 0.77 | 1.14 |
| 4 | decoupled | decoupled | decoupled | coupled | 0.88 | 1.14 |
| 5 | decoupled | coupled | decoupled | coupled | 1.00 | 1.14 |
| 6 | coupled | coupled | decoupled | coupled | 1.14 | 1.14 |
| 7 | decoupled | decoupled | coupled | coupled | 1.30 | 1.14 |
| 8 | decoupled | coupled | coupled | coupled | 1.48 | 1.14 |
| 9 | coupled | coupled | coupled | coupled | 1.69 | 1.14 |
| | | | | | 285% | |

Tables 4-6 show more examples of transmission ratios obtainable with the nine-speed planetary transmission of FIG. 11A-B. A first one of three-speed planetary transmissions is selectively operable according to transmission ratios R1, R2, and R3, using the first actuatable clutch C and the second actuatable clutch C2. A second one of three-speed planetary transmissions is selectively operable according to transmission ratios R4, R5, and R6, using the third actuatable clutch C3 and the fourth actuatable clutch C4.

TABLE 4

| | | First three-speed | | | Second three-speed | | |
|---|---|---|---|---|---|---|---|
| Step: 1.22 | | R1 | R2 | R3 | R4 | R5 | R6 |
| 1 | 0.45 | 0.55 | 1.00 | 1.81 | 0.82 | 1.00 | 1.22 |
| 2 | 0.55 | 0.55 | 1.00 | 1.81 | 0.82 | 1.00 | 1.22 |
| 3 | 0.67 | 0.55 | 1.00 | 1.81 | 0.82 | 1.00 | 1.22 |
| 4 | 0.82 | 0.55 | 1.00 | 1.81 | 0.82 | 1.00 | 1.22 |
| 5 | 1.00 | 0.55 | 1.00 | 1.81 | 0.82 | 1.00 | 1.22 |
| 6 | 1.22 | 0.55 | 1.00 | 1.81 | 0.82 | 1.00 | 1.22 |
| 7 | 1.48 | 0.55 | 1.00 | 1.81 | 0.82 | 1.00 | 1.22 |
| 8 | 1.81 | 0.55 | 1.00 | 1.81 | 0.82 | 1.00 | 1.22 |
| 9 | 2.21 | 0.55 | 1.00 | 1.81 | 0.82 | 1.00 | 1.22 |
| | 491% | | | | | | |

TABLE 5

| | | First three-speed | | | Second three-speed | | |
|---|---|---|---|---|---|---|---|
| Step: 1.20 | | R1 | R2 | R3 | R4 | R5 | R6 |
| 1 | 0.48 | 0.58 | 1.00 | 1.72 | 0.83 | 1.00 | 1.19 |
| 2 | 0.58 | 0.58 | 1.00 | 1.72 | 0.83 | 1.00 | 1.19 |
| 3 | 0.69 | 0.58 | 1.00 | 1.72 | 0.83 | 1.00 | 1.19 |
| 4 | 0.83 | 0.58 | 1.00 | 1.72 | 0.83 | 1.00 | 1.19 |
| 5 | 1.00 | 0.58 | 1.00 | 1.72 | 0.83 | 1.00 | 1.19 |
| 6 | 1.19 | 0.58 | 1.00 | 1.72 | 0.83 | 1.00 | 1.19 |
| 7 | 1.43 | 0.58 | 1.00 | 1.72 | 0.83 | 1.00 | 1.19 |
| 8 | 1.72 | 0.58 | 1.00 | 1.72 | 0.83 | 1.00 | 1.19 |
| 9 | 2.06 | 0.58 | 1.00 | 1.72 | 0.83 | 1.00 | 1.19 |
| | 430% | | | | | | |

TABLE 6

| | | First three-speed | | | Second three-speed | | |
|---|---|---|---|---|---|---|---|
| Step: 1.18 | | R1 | R2 | R3 | R4 | R5 | R6 |
| 1 | 0.52 | 0.61 | 1.00 | 1.64 | 0.85 | 1.00 | 1.18 |
| 2 | 0.61 | 0.61 | 1.00 | 1.64 | 0.85 | 1.00 | 1.18 |
| 3 | 0.72 | 0.61 | 1.00 | 1.64 | 0.85 | 1.00 | 1.18 |
| 4 | 0.85 | 0.61 | 1.00 | 1.64 | 0.85 | 1.00 | 1.18 |
| 5 | 1.00 | 0.61 | 1.00 | 1.64 | 0.85 | 1.00 | 1.18 |
| 6 | 1.18 | 0.61 | 1.00 | 1.64 | 0.85 | 1.00 | 1.18 |
| 7 | 1.39 | 0.61 | 1.00 | 1.64 | 0.85 | 1.00 | 1.18 |
| 8 | 1.64 | 0.61 | 1.00 | 1.64 | 0.85 | 1.00 | 1.18 |
| 9 | 1.94 | 0.61 | 1.00 | 1.64 | 0.85 | 1.00 | 1.18 |
| | 376% | | | | | | |

By only omitting the second clutch module from the example of FIG. 11A-B, a six-speed transmission can be obtained. An example of the transmission ratios obtainable with such six-speed transmission is given in table 7. Note that table 7 corresponds to the lower part of table 4, i.e. gears 1-6 of table 7 correspond to gears 4-9 of table 4.

TABLE 7

| | |
|---|---|
| First three-speed | Second three-speed |

| | | | | | |
|---|---|---|---|---|---|
| Step: 1.22 | R2 | R3 | R4 | R5 | R6 |

| | | | | | | |
|---|---|---|---|---|---|---|
| 1 | 0.82 | 1.00 | 1.81 | 0.82 | 1.00 | 1.22 |
| 2 | 1.00 | 1.00 | 1.81 | 0.82 | 1.00 | 1.22 |
| 3 | 1.22 | 1.00 | 1.81 | 0.82 | 1.00 | 1.22 |
| 4 | 1.48 | 1.00 | 1.81 | 0.82 | 1.00 | 1.22 |
| 5 | 1.81 | 1.00 | 1.81 | 0.82 | 1.00 | 1.22 |
| 6 | 2.21 | 1.00 | 1.81 | 0.82 | 1.00 | 1.22 |
| | 270% | | | | | |

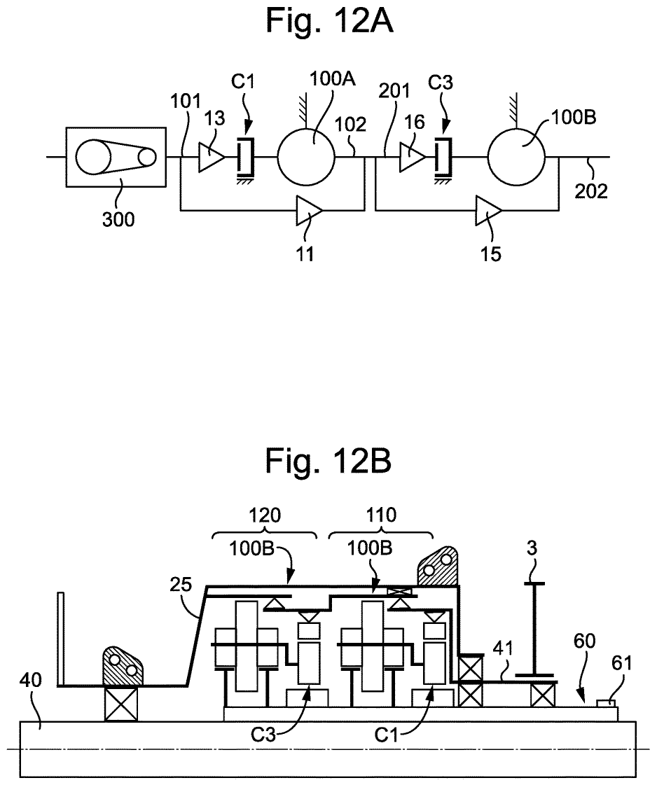

FIGS. 12A-12B schematically show an example of the bicycle transmission system 1000, comprising two two-speed planetary transmissions connected to each other in series. A four-speed transmission system 1000 can hence be obtained. The planetary gear sets of the two-speed planetary transmissions are in this example similar to each other and correspond to the exemplary planetary gear set of the two-speed planetary transmission system 1000 as described in view of FIGS. 6A-6C. It will however be appreciated that any of the two-speed planetary transmissions in this example can be exchanged for another two-speed planetary transmission, e.g. as described in view of FIGS. 5-8.

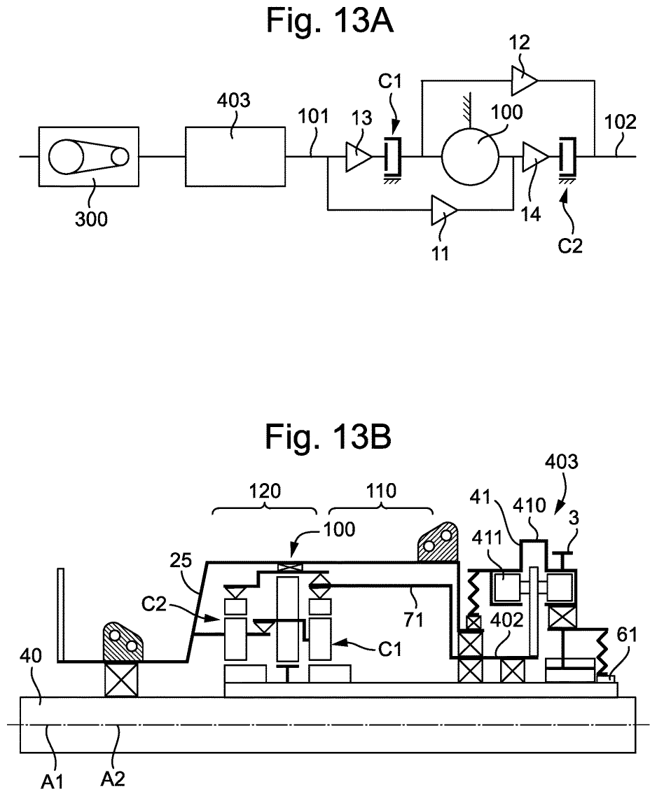

FIGS. 13A-13B schematically show an example of the bicycle transmission system 1000, comprising a continuously variable transmission, (CVT) 403. The CVT 403 is, here particularly of a ratcheting type. The CVT 403 includes a first drive element 410, here forming an input of the CVT 403, and a second drive element 402, here forming an output of the CVT 403. The first drive element 410 is rotatable about the first axis A1. The second drive element 402 is rotatable about a second axis A2. Torque can be transmitted from the first drive element 410 to the second drive element 402 by means of coupling elements 411. The coupling elements 411 are concentrically arranged with respect to the first axis A1, at a constant first radius from the first axis A1. The first drive element 410 and the second drive element 402 are movable, e.g. translatable or pivotable, relative to one another in a direction transverse to the first and second axis A1, A2, e.g. for providing an offset between the first axis A1 and the second axis A2. Torque can be transmitted from the first drive element 410 to the second drive element 402, or vice versa, by means of the coupling elements 411, at a variable second radius from the second axis A2. Hence, torque can be transferred from the constant first radius to the variable second radius. Hence, various ratios between the first radius and second radius can be obtained, depending on the offset between the first drive element 410 and the second drive element 402, resulting in various transmission ratios between the first drive element 410 and the second drive element 402.

Here, the first drive element 410 is associated with, e.g. integrated with, the driver 41. Also, here, the second drive element 402 is connectable to the hub shell 25, e.g. via the three-speed planetary transmission and/or the two-speed planetary transmission 100. It will be appreciated that it is also possible that the first drive element 410 is connectable to the hub shell 25, e.g. via the three-speed planetary transmission and/or the two-speed planetary transmission 100, and the second drive element 402 is associated with, e.g. integrated with, the driver 41. The driver 41 is in this example movable relative to the hub shell 25 in a direction transverse to the first and second axes A1, A2, so as to change a transmission ratio of the CVT 403.

FIG. 13B shows the driver 41, being here integrated with the first drive element 410 of the CVT 403, in a concentric position relative to the second drive element 402 of the CVT 403. In the concentric position, the first axis A1 coincides with the second axis A2. In the concentric position, the CVT 403 operates according to unitary transmission ratio, i.e. a 1:1 ratio. The driver 41 is movable from the concentric position to an eccentric position, in which the first axis A1 is offset from the second axis A2. In the eccentric position, the CVT 403 operates according to a nonunitary transmission ratio, in particular a speed-up ratio.

In the example of FIGS. 13A-13B, the transmissions system includes a three-speed planetary transmission as described herein. The three-speed planetary transmission is housed by the hub shell 25, in this example in the second cavity 120. The first cavity 110 here includes the first bridging element 71. The CVT 403 output is in this example connected to the first bridging element 71, which in turn is connected to the three-speed planetary input. Although the CVT 403 may include one or more freewheels that allow for coasting, an additional freewheel may be provided between the CVT 403 output and the first cavity 110, for increased coasting efficiency.

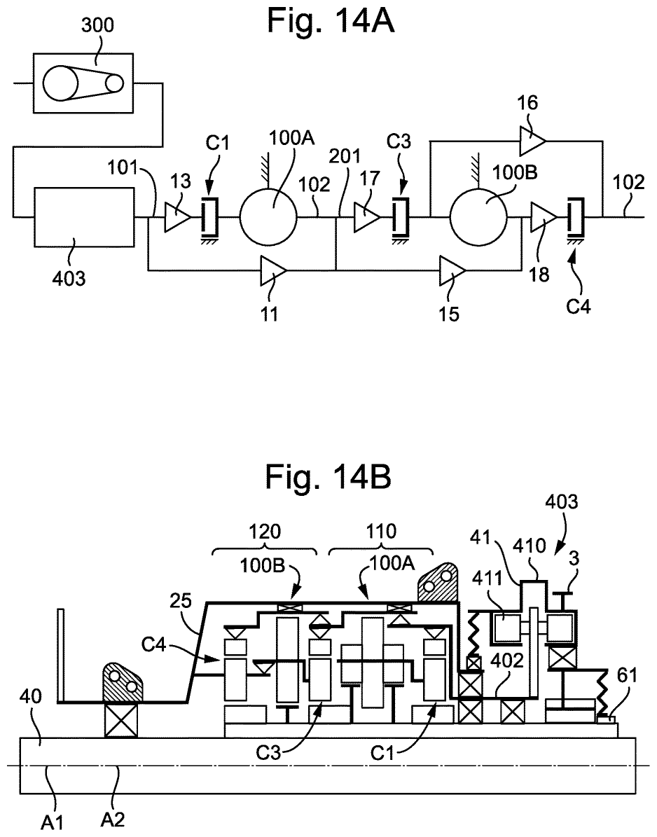

FIGS. 14A-14B schematically show another example of the bicycle transmission system 1000, wherein, in addition to the example as shown in FIGS. 13A-13B, the transmission system 1000 includes a three-speed planetary transmission connected in series to the two-speed planetary transmission. The two-speed planetary transmission is, here, held by the first cavity 110. The transmission system 1000 of this example is accordingly similar to the example of FIGS. 9A-9B, wherein the example of FIGS. 14A-14B further comprises the CVT 403.

The CVT 403 can be operated according to predetermined discrete transmission ratios. In combination with the transmission(s) in the first cavity and/or the second cavity, the bicycle transmission system can then be operated according to any desired number of discrete transmission ratios. The number and step size of the bicycle transmission ratios can be predetermined, or user defined and/or modified e.g. using an app running on a mobile device such as a smartphone.

The exemplary bicycle transmission system 1000 as shown in FIG. 14A-14B, has be configured to be operated according to a twelve-speed transmission system 1000 as shown in table 8. The three-speed planetary transmission is in this example operable according to transmission ratios of 0.76, 1.00 and 1.32, and the two-speed planetary transmission according to transmission ratios of 1.00 and 2.31

TABLE 8

| | | | | CVT | | |
|---|---|---|---|---|---|---|
| | C1 | C2 | C3 | 403 | Ratio | Step |
| 1 | decoupled | decoupled | decoupled | 1.00 | 0.76 | — |
| 2 | decoupled | decoupled | decoupled | 1.15 | 0.87 | 1.15 |
| 3 | decoupled | coupled | decoupled | 1.00 | 1.00 | 1.14 |
| 4 | decoupled | coupled | decoupled | 1.15 | 1.15 | 1.15 |
| 5 | coupled | coupled | decoupled | 1.00 | 1.32 | 1.14 |
| 6 | coupled | coupled | decoupled | 1.15 | 1.51 | 1.15 |
| 7 | decoupled | decoupled | coupled | 1.00 | 1.76 | 1.16 |
| 8 | decoupled | decoupled | coupled | 1.15 | 2.02 | 1.15 |
| 9 | decoupled | coupled | coupled | 1.00 | 2.31 | 1.14 |
| 10 | decoupled | coupled | coupled | 1.15 | 2.66 | 1.15 |
| 11 | coupled | coupled | coupled | 1.00 | 3.04 | 1.14 |
| 12 | coupled | coupled | coupled | 1.15 | 3.50 | 1.15 |
| | | | | | 460% | |

For the exemplary twelve-speed transmission system of table 8, the CVT 403 is operated according a predefined subset of transmission ratios within the continuous range of transmission ratios. Here, the CVT 403 is operated according to only two transmission ratios, namely unitary transmission ratio, i.e. 1.00, and a speed-increasing transmission ratio of 1.15. Hence, compared to the example of FIGS. 9A-9B and table 2, the CVT 403 provides in this example intermediate transmission ratio steps, between the six transmission ratios obtained from the serially arranged three-speed planetary transmission and the two-speed planetary transmission 100.

Similarly, table 9 shows another example of transmission ratios obtainable with the bicycle transmission system 1000 as shown in FIGS. 10A-10B. The three-speed planetary transmission is in this example operable according to transmission ratios of 0.76, 1.00 and 1.32, and the two-speed planetary transmission according to transmission ratios of 1.00 and 2.31

TABLE 9

| | | | | CVT | | |
|---|---|---|---|---|---|---|
| | C1 | C2 | C3 | 403 | Ratio | Step |
| 1 | decoupled | decoupled | decoupled | 1.00 | 0.76 | — |
| 2 | decoupled | decoupled | decoupled | 1.10 | 0.84 | 1.10 |
| 3 | decoupled | decoupled | decoupled | 1.20 | 0.91 | 1.09 |
| 4 | decoupled | coupled | decoupled | 1.00 | 1.00 | 1.10 |
| 5 | decoupled | coupled | decoupled | 1.10 | 1.10 | 1.10 |
| 6 | decoupled | coupled | decoupled | 1.20 | 1.20 | 1.09 |
| 7 | coupled | coupled | decoupled | 1.00 | 1.32 | 1.10 |
| 8 | coupled | coupled | decoupled | 1.10 | 1.45 | 1.10 |
| 9 | coupled | coupled | decoupled | 1.20 | 1.60 | 1.10 |
| 10 | decoupled | decoupled | coupled | 1.00 | 1.76 | 1.10 |
| 11 | decoupled | decoupled | coupled | 1.10 | 1.93 | 1.10 |
| 12 | decoupled | decoupled | coupled | 1.20 | 2.11 | 1.09 |
| 13 | decoupled | coupled | coupled | 1.00 | 2.31 | 1.10 |
| 14 | decoupled | coupled | coupled | 1.10 | 2.54 | 1.10 |
| 15 | decoupled | coupled | coupled | 1.20 | 2.77 | 1.09 |
| 16 | coupled | coupled | coupled | 1.00 | 3.04 | 1.10 |
| 17 | coupled | coupled | coupled | 1.10 | 3.34 | 1.10 |
| 18 | coupled | coupled | coupled | 1.20 | 3.65 | 1.09 |
| | | | | | 480% | |

With the example of table 9, an eighteen-speed transmission system 1000 can be obtained, wherein the CVT 403 is operated according to a predefined subset of transmission ratios within the continuous range of transmission ratios, here switching between three different transmission ratios, namely a unitary transmission ratio, i.e. 1.00, and two speed-increasing transmission ratios of 1.10 and 1.20.

Similarly, table 10 shows a twenty-four-speed transmission system 1000 obtainable with the bicycle transmission system 1000 as shown in FIGS. 10A-10B. The CVT 403 is in this example operated according to four different transmission ratios. The three-speed planetary transmission is in this example operable according to transmission ratios of 0.76, 1.00 and 1.32, and the two-speed planetary transmission according to transmission ratios of 1.00 and 2.31

TABLE 10

| | | | | CVT | | |
|---|---|---|---|---|---|---|
| | C1 | C2 | C3 | 403 | Ratio | Step |
| 1 | decoupled | decoupled | decoupled | 1.00 | 0.76 | |
| 2 | decoupled | decoupled | decoupled | 1.07 | 0.81 | 1.07 |
| 3 | decoupled | decoupled | decoupled | 1.14 | 0.87 | 1.07 |
| 4 | decoupled | decoupled | decoupled | 1.23 | 0.93 | 1.07 |
| 5 | decoupled | coupled | decoupled | 1.00 | 1.00 | 1.08 |
| 6 | decoupled | coupled | decoupled | 1.07 | 1.07 | 1.07 |
| 7 | decoupled | coupled | decoupled | 1.14 | 1.14 | 1.07 |
| 8 | decoupled | coupled | decoupled | 1.23 | 1.23 | 1.07 |
| 9 | coupled | coupled | decoupled | 1.00 | 1.32 | 1.07 |
| 10 | coupled | coupled | decoupled | 1.07 | 1.41 | 1.07 |
| 11 | coupled | coupled | decoupled | 1.14 | 1.51 | 1.07 |
| 12 | coupled | coupled | decoupled | 1.23 | 1.61 | 1.07 |
| 13 | decoupled | decoupled | coupled | 1.00 | 1.76 | 1.07 |
| 14 | decoupled | decoupled | coupled | 1.07 | 1.88 | 1.07 |
| 15 | decoupled | decoupled | coupled | 1.14 | 2.01 | 1.07 |
| 16 | decoupled | decoupled | coupled | 1.23 | 2.15 | 1.07 |
| 17 | decoupled | coupled | coupled | 1.00 | 2.31 | 1.07 |
| 18 | decoupled | coupled | coupled | 1.07 | 2.47 | 1.07 |
| 19 | decoupled | coupled | coupled | 1.14 | 2.64 | 1.07 |
| 20 | decoupled | coupled | coupled | 1.23 | 2.83 | 1.07 |
| 22 | coupled | coupled | coupled | 1.00 | 3.04 | 1.07 |
| 21 | coupled | coupled | coupled | 1.07 | 3.25 | 1.07 |
| 23 | coupled | coupled | coupled | 1.14 | 3.48 | 1.07 |
| 24 | coupled | coupled | coupled | 1.23 | 3.72 | 1.07 |
| | | | | | 490% | |

Accordingly, with the transmission system 1000 including the CVT 403, such as the transmission system 1000 shown in FIGS. 14A-14B, various customizable sets of system transmission ratios can be obtained. For example, the twelve-speed of table 8, the eighteen-speed of table 9 and the twenty-four-speed of table 10, can all be obtained with the same transmission system 1000 as shown in FIG. 14A-14B.

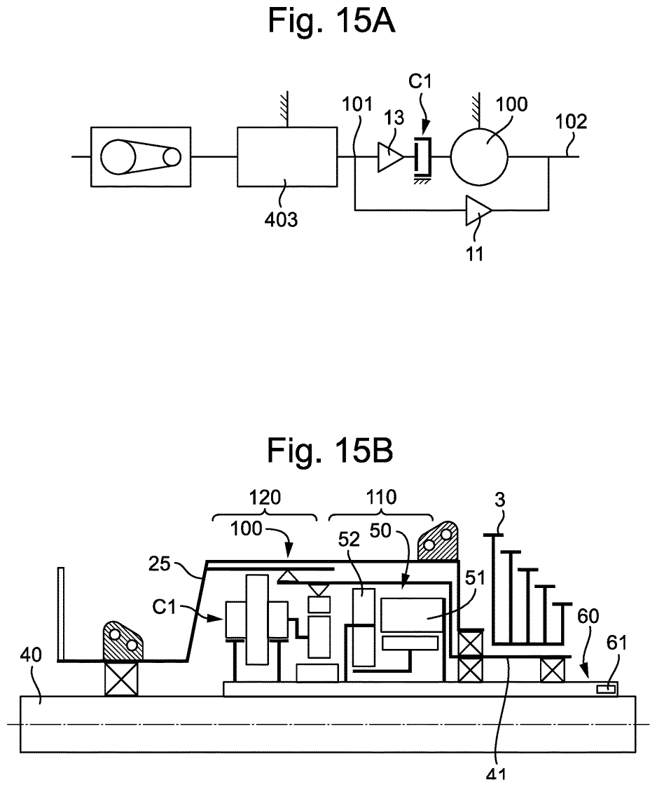

FIGS. 15A-15B schematically show an example of the bicycle transmission system 1000, comprising an electric propulsion motor module 50. The electric propulsion motor module 50 includes an electric motor 51 configured for propelling, or at least assist in propelling, the bicycle. The electric propulsion motor module 50 is here held by the first cavity 110, but the it will be appreciated that the propulsion motor module 50 may alternatively be held by the second cavity 120, or that the both the first cavity 110 and the second cavity 120 hold the, or a, propulsion motor module 50. Here, the electric propulsion motor module 50 is coupled or couplable to the two-speed planetary transmission input 101, but it will be appreciated that the electric propulsion module may be combined with any other planetary transmission and/or CVT 403 as described herein. In this example, the electric propulsion motor module 50 includes a reduction gear 52, between electric propulsion motor 51 and the two-speed planetary transmission input 101. The electric propulsion motor 51 is here also configured to act as a generator, for converting mechanic power to electric power, e.g. for powering a clutch actuator of the actuatable clutches. Alternatively, the transmission system 1000 may include a dedicated generator, e.g. instead of the electric propulsion motor 51 or in addition to the electric propulsion motor 51.

In the example of FIGS. 4-8 the transmission system includes a set of a plurality of sprockets 3, such as a cassette. It will be appreciated that the plurality of sprockets may also be used in the other examples. In the example of FIGS. 3, 9-14, the transmission system includes a set of a single sprocket 3. It will be appreciated that a set of a single sprocket may also be used in the other examples. In the example of FIGS. 13B and 14B the transmission system includes a CVT 403. It will be appreciated that the CVT may also be used in the other examples.

In the example of FIGS. 3B, 3C, 9B, 9B, 11B, 13B and 14B the three-speed planetary transmission is housed in the hub shell having the first and second cavities. It will be appreciated that the three-speed planetary transmission can also be housed in a hub shell having a single cavity, only for the three speed planetary transmission. Alternatively, the three-speed planetary transmission can be housed in a driver body attachable to a hub shell. The three-speed planetary transmission housed in the hub shell having the single cavity, or housed in the driver body, can be used in combination with a single sprocket, a plurality of sprockets, or a CVT.

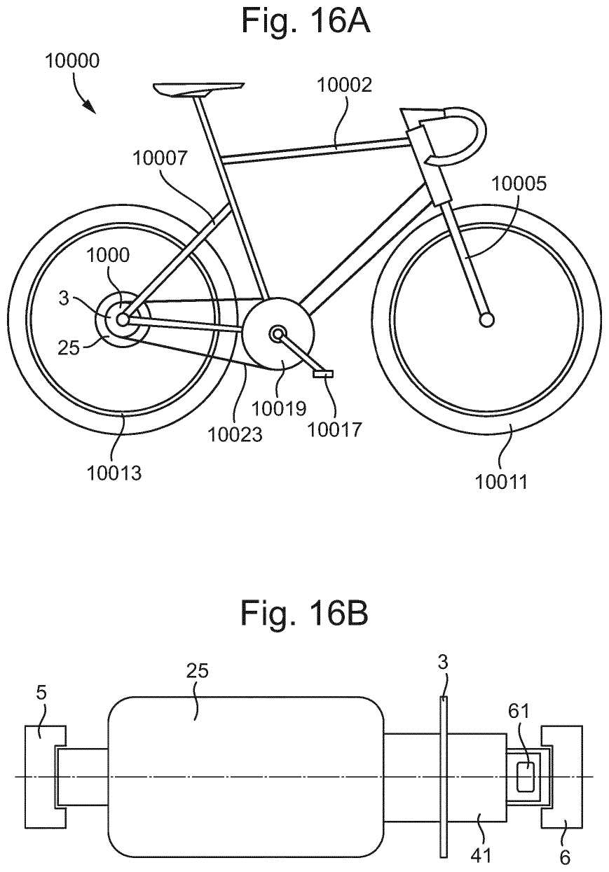

FIG. 16A shows a bicycle 10000. The bicycle 10000 comprises a frame 10002 with a front fork 10005 and a rear fork 10007, as well as a front wheel and a rear wheel 10011, 10013 located in the front and rear fork respectively. The bicycle 10000 further comprises a crank 10017, and a front chain wheel 10019. The comprises a transmission system 1000, in this example embodied as a hub transmission. The bicycle 10000 also comprises a set of sprockets 3, wherein a chain 10023 threads over the front chain wheel 10019 and one of the sprockets 3. The bicycle here includes a derailleur 10024. Alternatively, the bicycle may be free of a derailleur.

FIG. 16B schematically shows the wheel hub assembly, here of the rear wheel 10013 of the bicycle 10000, wherein the transmission system 1000 is arranged between a left dropout 5 and a right dropout 6 of the rear fork 100017 of the bicycle frame 10002. The transmission system 1000 here includes an antenna module 60, wherein the antenna 61 is arranged, in axial direction, between the drive-side dropout, here the right dropout 6, and the hub shell 25, more particularly between the drive-side dropout and the driver 41.

The figures show various examples of the bicycle transmission system 1000, particularly of a modular bicycle transmission, in which various features, elements, and modules can be combined, including CVT's, bridging elements, and propulsion motors/generators, etc., and it will be appreciated that other combinations are also conceived.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1-78. (canceled)

79. A bicycle transmission system, comprising
a planetary transmission having three rotational members;
wherein the planetary transmission comprises a first clutch module and/or a second clutch module;
the first clutch module including a first actuatable clutch in a transmission path between a planetary transmission input and a first one of the rotational members, and a first freewheel in a transmission path between the planetary transmission input and a second one of the rotational members, and
the second clutch module including a second actuatable clutch in a transmission path between the second one of the rotational members and a planetary transmission output, and a second freewheel in a transmission path between the first one of the rotational members and the planetary transmission output;
wherein at least one of the first actuatable clutch and the second actuatable clutch has a respective clutch input, and a clutch output, and includes:
a first rotatable unit connectable to the input, including at least one first abutment surface;
a second rotatable unit connectable to the output, including at least one second abutment surface arranged for selectively engaging the first abutment surface, the first and second abutment surfaces being adapted to each other so as to allow disengaging under load;
a third rotatable unit including at least one retaining member, the third rotatable unit being arranged for selectively being in a first position or a second position relative to the second rotatable unit, wherein the at least one retaining member in the first position locks the at least one second abutment surface in engagement with the at least one first abutment surface for rotationally coupling the second rotatable unit to the first rotatable unit, and in the second position releases the at least one second abutment surface for disengagement of the at least one first abutment surface for decoupling the second rotatable unit from the first rotatable unit.

80. The transmission system of claim 79, wherein a third one of the rotational members can be non-rotatably fixed to a stationary part.

81. The transmission system of claim 80, wherein the third one of the rotational members is a sun gear.

82. The transmission system of claim 79, wherein the first one of the rotational members is a planet carrier carrying one or more planet gears, and the second one of the rotational members is a ring gear.

83. The transmission system of claim 79, wherein the first actuatable clutch and the second actuatable clutch are identical.

84. The transmission system of claim 79, wherein the first actuatable clutch and the second actuatable clutch are form closed clutches, configured for transferring torque in two rotation directions.

85. The transmission system of claim 79, comprising a first electric actuator arranged for actuating the first actuatable clutch, and a second electric actuator arranged for actuating the second actuatable clutch.

86. The transmission system of claim 79, wherein the first actuatable clutch and the second actuatable clutch are independently actuatable.

87. The transmission system of claim 79, wherein the first clutch module includes a third freewheel in a transmission path between the planetary transmission input and the first actuatable clutch or between the first actuatable clutch and the first one of the rotational members.

88. The transmission system of claim 79, wherein the second clutch module includes a fourth freewheel in a transmission path between the second one of the rotational members and the second actuatable clutch or between the second actuatable clutch and the planetary transmission output.

89. The transmission system of claim 79, wherein the planetary transmission is selectively operable according to a unitary transmission ratio.

90. The transmission system of claim 79, wherein each one of the first actuatable clutch and the second actuatable clutch is configured for being coupled and decoupled under load.

91. The transmission system of claim 79, wherein the third rotatable unit includes at least one actuation member arranged for moving the third rotatable unit from a first position to a second position or from a second position to a first position relative to the second rotatable unit.

92. The transmission system of claim 79, wherein each actuatable clutch includes a fourth unit including a selector, the selector being arranged for selectively being in a gripping or non-gripping mode,
the selector in the gripping mode being arranged for gripping the at least one actuation member for rotating the third rotatable unit from the first position to the second position or from the second position to the first position relative to the second rotatable unit;
the selector in the non-gripping mode being arranged for not engaging the at least one actuation member.

93. The transmission system of claim 79, wherein the first clutch input is connected to the planetary transmission input, and the first clutch output is connected to the first one of the rotational members; and/or wherein the second clutch input is connected to the second one of the rotational members and the second clutch output is connected to the planetary transmission output.

94. The transmission system of claim 82, wherein the one or more planet gears are stepped planet gears including a large-radius gear part and a small-radius gear part rotationally fixed to each other.

95. The transmission system of claim 79, comprising a further planetary transmission having three further rotational members, wherein a third one of the further rotational members is non-rotatably fixed to the stationary axle.
wherein the further planetary transmission comprises a third clutch module and/or a fourth clutch module;
the third clutch module including a third actuatable clutch in a transmission path between a further planetary transmission input and a first one of the further rotational members, and a fifth freewheel in a transmission path between the further planetary transmission input and a second one of the further rotational members,
the fourth clutch module including a fourth actuatable clutch in a transmission path between the second one of the further rotational members and a further planetary transmission output, and a sixth freewheel in a transmission path between the first one of the further rotational members and the further planetary transmission output.

96. The transmission system of claim 95, wherein the first one of the further rotational members is a further planet carrier carrying one or more stepped further planet gears, and the second one of the further rotational members is a further ring gear.

97. A bicycle, comprising the transmission system of claim 79.

98. An electrically powered vehicle, comprising an electric propulsion motor having an output power of maximum 88 kW, preferably maximum 82 kW; the electric propulsion motor being arranged for driving a driven wheel of the vehicle, wherein the transmission system of claim 79 is arranged in a transmission path between the electric propulsion motor and the driven wheel.
